(19) United States
(12) Patent Application Publication
(10) Pub. No.: US 2026/0260413 A1
(43) Pub. Date: Sep. 3, 2026

(54) REAL-TIME RENDERING SYSTEM AND METHOD

(71) Applicant: BOE Technology Group Co., Ltd., Beijing (CN)

(72) Inventors: Zhe ZHANG, Beijing (CN); Sujia JIANG, Beijing (CN); Naichuan CHEN, Beijing (CN); Danfeng ZHU, Beijing (CN); Yue YU, Beijing (CN); Jing YU, Beijing (CN)

(21) Appl. No.: 18/995,636

(22) PCT Filed: Aug. 14, 2023
(86) PCT No.: PCT/CN2023/112901

§ 371 Date: Jan. 16, 2025

(51) Int. Cl. G06T 15/00; G06T 5/00

(52) U.S. Cl. CPC G06T 15/005; G06T 5/00; G06T 2200/24; G06T 2207/10016; G06T 2210/36

(57) ABSTRACT

A real-time rendering system and method. The system includes a server side and a client: the server side generates an application file and an access address of an application, and configures transmission parameters of the application, and the application file includes a three-dimensional scenario model and logic codes of the application; the server side generates the rendered stream according to the application file, the rendered stream is associated with the access address, and the rendered stream is used for displaying the three-dimensional scenario model of the application in a manner of a video stream; and the client obtains the access address of the application, establishes communication connection with the server side according to the access address, receives the rendered stream sent by the server side based on the transmission parameters, and performs playing and displaying on the received rendered stream through a client playing medium.

### CROSS-REFERENCE TO RELATED APPLICATIONS

This application is a National Stage of International Application No. PCT/CN2023/112901, filed on Aug. 14, 2023, the content of which is hereby incorporated by reference in its entirety.

### TECHNICAL FIELD

The present disclosure relates to the technical field of three-dimensional rendering, and in particular to a real-time rendering system and method.

### BACKGROUND

With the increasing maturity of the 5G technology, the continuous upgrading of technologies such as Artificial Intelligence (AI), Internet of Things (IoT) and cloud computing, and various possibilities in the metaverse era, three-dimensional rendering scenarios are very widely applied in related fields such as digital twins and visualization applications. The industry and enterprise development also has higher and higher requirements for real-time three-dimensional rendering technologies, and more application scenarios require the simultaneous use of multiple ability combinations.

The three-dimensional rendering scenarios can use three-dimensional rendering engines to assist the development of service applications, but due to the virtualization properties of the three-dimensional rendering scenarios themselves, the actual development and construction process can be exceptionally cumbersome. Existing three-dimensional rendering services are generally deployed on terminals and require the development of corresponding three-dimensional rendering services based on network environment platforms of different terminals, making it impossible to achieve cross-platform deployment.

### SUMMARY

The present disclosure provides a real-time rendering system and method, for achieving cross-platform deployment of a rendering service on clients in different network environments in a manner of generating a rendered stream through a server side and pushing the rendered stream to the clients.

In a first aspect, a real-time rendering system according to an embodiment of the present disclosure includes a server side and a client, where:
the server side generates an application file and an access address of an application, and configures transmission parameters of the application, the application file includes a three-dimensional scenario model and logic codes of the application, and the transmission parameters are used for representing parameters required when the application is transmitted from the server side to the client for being displayed;
the server side generates a rendered stream according to the application file, the rendered stream is associated with the access address, and the rendered stream is used for displaying the three-dimensional scenario model of the application in a manner of a video stream; and
the client obtains the access address of the application, establishes communication connection with the server side according to the access address, receives the rendered stream sent by the server side based on the transmission parameters, and performs playing and displaying on the received rendered stream through a client playing medium.

As an optional implementation, the server side includes a rendering system and a real-time communication server, and the real-time communication server is configured to establish communication connection between the rendering system and the client based on a real-time communication technology; and the server side is configured to:
generate the application file of the application by using the rendering system, configure the transmission parameters of the application and upload the transmission parameters to the real-time communication server; and
generate the access address of the application by using the real-time communication server.

As an optional implementation, after the server side generates the access address of the application by using the real-time communication server, the following is further included:
the server side uploads the access address to a service platform, and the server side generates the rendered stream according to the application file and sends the rendered stream to the real-time communication server; and
the client obtains the access address of the application from the service platform, establishes communication connection with the real-time communication server according to the access address, and receives the rendered stream sent by the real-time communication server.

As an optional implementation, the rendering system includes a three-dimensional rendering engine and a pixel streaming plug-in; and the server side is configured to:
generate the application file of the application by using the three-dimensional rendering engine; and
generate a pixel stream of the application based on the application file by using the three-dimensional rendering engine, and convert the pixel stream into the rendered stream by using the pixel streaming plug-in.

As an optional implementation, the rendering system includes a configuration interface; and the server side is configured to:
display a configuration option of the application on the configuration interface; and configure the transmission parameters of the application in response to transmission parameters input by a user in the configuration option of the configuration interface; or,
configure the transmission parameters of the application based on self-defined transmission parameters.

As an optional implementation,
the real-time communication server includes a signaling service, and the signaling service is used for enabling interaction of a plurality of types of signaling between the server side and the client; and/or,
the client includes a client engine, and the client engine is configured to be connected with the signaling service and perform interaction of a plurality of types of signaling with the signaling service.

As an optional implementation, the real-time communication server includes a signaling service;
the signaling service is used for establishing communication connection between the rendering system and the client playing medium; or,
the signaling service is used for establishing communication connection between the real-time communication server and the client playing medium; or,
the signaling service is used for establishing a communication service between the client and the client playing medium.

As an optional implementation, the client includes the client engine, the client playing medium includes a player, the player is packaged based on Flutter language and supports a plurality of transmission protocols, and the player is applied to clients in different network environments;
in response to an interaction instruction executed by a user on the player, the client sends the interaction instruction to the signaling service through the client engine; and
the signaling service sends the interaction instruction to the rendering system, and the rendering system responds to the interaction instruction and sends a response result to the player through the signaling service.

As an optional implementation, the client playing medium includes a browser; and the server side is configured to:
in a case that the client, in response to an interaction instruction executed by a user on the browser, sends the interaction instruction to the signaling service,
send the interaction instruction to the rendering system by using the signaling service, respond to, by the rendering system, the interaction instruction and send a response result to the browser through the signaling service.

As an optional implementation, the signaling service includes a player service and a streamer service;
the client playing medium includes the player, and the server side is configured to:
send the interaction instruction to the client engine by using the player service, and send the interaction instruction to the signaling service through the client engine; and send the response result to the player by using the streamer service; or,
the client playing medium includes the browser, and the server side is configured to:
send the interaction instruction to the signaling service by using the player service; and send the response result to the browser by using the streamer service.

As an optional implementation, the application file further includes interaction logic codes, the rendered stream further includes a UI interaction interface, and the interaction logic codes are used for generating the UI interaction interface; and
after the playing and displaying is performed on the received rendered stream through the client playing medium, the following is further included:
in response to an operation instruction of a user on the UI interaction interface, the client playing medium sends the operation instruction to the server side; and
the server side executes a corresponding operation according to the operation instruction, and sends an operated UI interaction result to the client playing medium.

As an optional implementation, the server side further includes a material warehouse; and the server side is further configured to:
upload the application file to the material warehouse, and generate a corresponding rendered stream according to the application file stored in the material warehouse.

As an optional implementation, the transmission parameters include a startup mode, and the startup mode is used for representing a maximum number of clients accessing a same three-dimensional rendering scenario of the application; and the server side is configured to:
configure the startup mode of the application, such that the same three-dimensional rendering scenario of the application is able to be accessed by a plurality of clients, and the plurality of clients are unable to operate a same element in the three-dimensional rendering scenario simultaneously.

As an optional implementation, the client is further configured to:
obtain a resource parameter set of a client device, where the resource parameter set includes at least one resource parameter, and the resource parameter is used for representing an operation state of the client device;
perform, in a case that the resource parameter set meets a first set condition, image enhancement processing on the rendered stream to obtain an enhanced video stream; and
perform playing and displaying on the enhanced video stream through the client playing medium.

As an optional implementation, the resource parameter set includes a stream pushing manner of a rendered stream and a network speed; and the first set condition includes:
a current network speed of the client device is less than or equal to a set network speed threshold; and/or,
a stream pushing manner of a rendered stream received by the client device at this time does not meet a preset requirement.

As an optional implementation, the stream pushing manner includes a resolution of a rendered stream; and the first set condition includes:
a resolution of a rendered stream received by the client device at this time is lower than or equal to a resolution of a rendered stream received last time.

As an optional implementation, the resource parameter set includes a network card configuration, and in a case that the resource parameter set meets the first set condition, the client is configured to:
determine a hardware resource used for image enhancement processing according to whether the network card configuration includes a discrete graphics card and an integrated graphics card; and
perform image enhancement processing on the rendered stream by using the hardware resource to obtain an enhanced video stream.

As an optional implementation, the resource parameter set further includes a CPU resource; and the client is configured to:
determine that the hardware resource used for image enhancement processing includes the integrated graphics card and the CPU resource in a case that the network card configuration includes the discrete graphics card and the integrated graphics card.

As an optional implementation, the resource parameter set further includes a GPU resource and a video memory resource; and the client is configured to:
determine that the hardware resource used for image enhancement processing includes the GPU resource in a case that the network card configuration does not have a condition of performing image enhancement processing in the integrated graphics card, the GPU resource is greater than or equal to a first threshold and the video memory resource is greater than or equal to a second threshold.

As an optional implementation, the resource parameter set further includes a GPU resource; and in a case that the resource parameter set meets the first set condition, the client is further configured to:
adjust an enhancement level of an image enhancement algorithm according to the GPU resource, and perform image enhancement processing on the rendered stream by using the adjusted image enhancement algorithm, where the enhancement level is used for representing an intensity of image enhancement.

As an optional implementation, the client is further configured to:
notify the server side to adjust the transmission parameters of the application in a case of monitoring that the resource parameter set meets the first set condition; or,
notify the server side to adjust the transmission parameters of the application in a case of monitoring that the resource parameter set meets the first set condition and meets a second set condition, where the second set condition includes: the resource parameters in the resource parameter set reach peak values, where one of the resource parameters corresponds to one of the peak values; or, a network speed in the resource parameter set is less than or equal to a network speed threshold.

As an optional implementation, the transmission parameters include a resolution of the rendered stream.

As an optional implementation, in a case that the resource parameter set meets the first set condition, the client is configured to:
perform stream decoding on the rendered stream to obtain a decoded video stream, and perform image enhancement processing on the decoded video stream to obtain an enhanced video stream.

As an optional implementation, the client is deployed on client devices in different network environments, and the network environments are used for representing operating systems or network services of the client devices; and/or,
the server side is deployed in a cloud server and/or a local area network server.

In a second aspect, a real-time rendering method according to an embodiment of the present disclosure includes:
obtaining, by a client, in response to a first operation of a user for an application in a service platform displayed by a client device, an access address of the application;
establishing communication connection with a server side according to the access address in response to a second operation of inputting the access address to a client playing medium by the user; and
receiving, by the client, a rendered stream associated with the access address sent by the server side, and performing playing and displaying on the received rendered stream through the client playing medium, where the rendered stream is used for displaying a three-dimensional scenario model of the application in a manner of a video stream.

As an optional implementation, the client includes a client engine, the client playing medium includes a player, the player is packaged based on Flutter language and supports a plurality of transmission protocols, and the player is applied to clients in different network environments; and the method further includes:
sending, by the client, in response to an interaction instruction executed by the user on the player, the interaction instruction to the server side through the client engine, to be used for the server side to respond to the interaction instruction and send a response result to the player; and
displaying, by the player, the received response result.

As an optional implementation, the client playing medium includes a browser; and the method further includes:
sending, by the client, in response to an interaction instruction executed by the user on the browser, the interaction instruction to the server side, to be used for the server side to respond to the interaction instruction and send a response result to the browser; and
displaying, by the browser, the received response result.

As an optional implementation, the rendered stream further includes a UI interaction interface, and the method further includes:
sending, by the client playing medium, in response to an operation instruction of the user on the UI interaction interface, the operation instruction to the server side, to be used for the server side to execute a corresponding operation according to the operation instruction and send an operated UI interaction result to the client playing medium; and
displaying, by the client playing medium, the received UI interaction result.

In a third aspect, a real-time rendering method according to an embodiment of the present disclosure includes:
generating an application file and an access address of an application by using a server side, and configuring transmission parameters of the application, where the application file includes a three-dimensional scenario model and logic codes of the application, and the transmission parameters are used for representing parameters required when the application is transmitted from the server side to a client for being displayed;
generating a rendered stream according to the application file by using the server side, where the rendered stream is associated with the access address, and the rendered stream is used for displaying the three-dimensional scenario model of the application in a manner of a video stream; and
obtaining the access address of the application by using the client, establishing communication connection with the server side according to the access address, receiving the rendered stream of the server side according to the transmission parameters, and performing playing and displaying on the received rendered stream through a client playing medium.

As an optional implementation, the server side includes a rendering system and a real-time communication server, and the real-time communication server is configured to establish communication connection between the rendering system and the client based on an RTC technology;
the application file of the application is generated by using the rendering system, the transmission parameters of the application are configured, and the transmission parameters are uploaded to the real-time communication server; and
the access address of the application is generated by using the real-time communication server.

As an optional implementation, after the server side generates the access address of the application by using the real-time communication server, the following is further included:
the server side uploads the access address to a service platform, and the server side generates the rendered stream according to the application file and sends the rendered stream to the real-time communication server; and
the client obtains the access address of the application from the service platform, establishes communication connection with the real-time communication server according to the access address, and receives the rendered stream sent by the real-time communication server.

As an optional implementation, the rendering system includes a three-dimensional rendering engine and a pixel streaming plug-in;
the application file of the application is generated by using the three-dimensional rendering engine; and
a pixel stream of the application is generated based on the application file by using the three-dimensional rendering engine, and the pixel stream is converted into the rendered stream by using the pixel streaming plug-in.

As an optional implementation, the rendering system includes a configuration interface;
a configuration option of the application is displayed on the configuration interface; and the transmission parameters of the application are configured in response to transmission parameters input by a user in the configuration option of the configuration interface; or,
the transmission parameters of the application are configured based on self-defined transmission parameters.

As an optional implementation, the real-time communication server includes a signaling service, and the signaling service is used for enabling interaction of a plurality of types of signaling between the server side and the client; and/or,
the client includes a client engine, and the client engine is configured to be connected with the signaling service and perform interaction of a plurality of types of signaling with the signaling service.

As an optional implementation, the real-time communication server includes a signaling service;
the signaling service is used for establishing communication connection between the rendering system and the client playing medium; or,
the signaling service is used for establishing communication connection between the real-time communication server and the client playing medium; or,
the signaling service is used for establishing a communication service between the client and the client playing medium.

As an optional implementation, the client includes the client engine, the client playing medium includes a player, the player is packaged based on Flutter language and supports a plurality of transmission protocols, and the player is applied to clients in different network environments;
in response to an interaction instruction executed by a user on the player, the client sends the interaction instruction to the signaling service through the client engine; and
the signaling service sends the interaction instruction to the rendering system, and the rendering system responds to the interaction instruction and sends a response result to the player through the signaling service.

As an optional implementation, the client playing medium includes a browser;
the client, in response to an interaction instruction executed by a user on the browser, sends the interaction instruction to the signaling service;
the interaction instruction is sent to the rendering system by using the signaling service, and the rendering system responds to the interaction instruction and sends a response result to the browser through the signaling service.

As an optional implementation, the signaling service includes a player service and a streamer service; and the client playing medium includes a player:
the interaction instruction is sent to the client engine by using the player service, and the interaction instruction is sent to the signaling service through the client engine; and the response result is sent to the player by using the streamer service; or,
the client playing medium includes a browser:
the interaction instruction is sent to the signaling service by using the player service; and the response result is sent to the browser by using the streamer service.

As an optional implementation, the application file further includes interaction logic codes, the rendered stream further includes a UI interaction interface, and the interaction logic codes are used for generating the UI interaction interface; and
after the playing and displaying is performed on the received rendered stream through the client playing medium, the following is further included:
in response to an operation instruction of a user on the UI interaction interface, the client playing medium sends the operation instruction to the server side; and
the server side executes a corresponding operation according to the operation instruction, and sends an operated UI interaction result to the client playing medium.

As an optional implementation, the server side further includes a material warehouse;
the application file is uploaded to the material warehouse, and a corresponding rendered stream is generated according to the application file stored in the material warehouse.

As an optional implementation, the transmission parameters include a startup mode, and the startup mode is used for representing a maximum number of clients accessing a same three-dimensional rendering scenario of the application;
the startup mode of the application is configured, such that the same three-dimensional rendering scenario of the application is able to be accessed by a plurality of clients, and the plurality of clients are unable to operate a same element in the three-dimensional rendering scenario simultaneously.

As an optional implementation, the method further includes:
obtaining a resource parameter set of a client device, where the resource parameter set includes at least one resource parameter, and the resource parameter is used for representing an operation state of the client device;
performing, in a case that the resource parameter set meets a first set condition, image enhancement processing on the rendered stream to obtain an enhanced video stream; and
performing playing and displaying on the enhanced video stream through the client playing medium.

As an optional implementation, the resource parameter set includes a stream pushing manner of a rendered stream and a network speed; and the first set condition includes:
a current network speed of the client device is less than or equal to a set network speed threshold; and/or,
a stream pushing manner of a rendered stream received by the client device at this time does not meet a preset requirement.

As an optional implementation, the stream pushing manner includes a resolution of a rendered stream; and the first set condition includes:
a resolution of a rendered stream received by the client device at this time is lower than or equal to a resolution of a rendered stream received last time.

As an optional implementation, the resource parameter set includes a network card configuration, and in a case that the resource parameter set meets the first set condition, a hardware resource used for image enhancement processing is determined according to whether the network card configuration includes a discrete graphics card and an integrated graphics card; and image enhancement processing is performed on the rendered stream by using the hardware resource to obtain an enhanced video stream.

As an optional implementation, the resource parameter set further includes a CPU resource; and
it is determined that the hardware resource used for image enhancement processing includes the integrated graphics card and the CPU resource in a case that the network card configuration includes the discrete graphics card and the integrated graphics card.

As an optional implementation, the resource parameter set includes a GPU resource and a video memory resource; and
it is determined that the hardware resource used for image enhancement processing includes the GPU resource in a case that the network card configuration does not have a condition of performing image enhancement processing in the integrated graphics card, the GPU resource is greater than or equal to a first threshold and the video memory resource is greater than or equal to a second threshold.

As an optional implementation, the resource parameter set further includes a GPU resource; and in a case that the resource parameter set meets the first set condition, the following is further included:
the client adjusts an enhancement level of an image enhancement algorithm according to the GPU resource, and performs image enhancement processing on the rendered stream by using the adjusted image enhancement algorithm, where the enhancement level is used for representing an intensity of image enhancement.

As an optional implementation, the method further includes:
notifying, by the client, the server side to adjust the transmission parameters of the application in a case of monitoring that the resource parameter set meets the first set condition; or,
notifying, by the client, the server side to adjust the transmission parameters of the application in a case of monitoring that the resource parameter set meets the first set condition and meets a second set condition, where the second set condition includes: the resource parameters in the resource parameter set reach peak values, where one of the resource parameters corresponds to one of the peak values; or, a network speed in the resource parameter set is less than or equal to a network speed threshold.

As an optional implementation, the transmission parameters include a resolution of the rendered stream.

As an optional implementation, in a case that the resource parameter set meets the first set condition, stream decoding is performed on the rendered stream to obtain a decoded video stream, and image enhancement processing is performed on the decoded video stream to obtain an enhanced video stream.

As an optional implementation, the client is deployed on client devices in different network environments, and the network environments are used for representing operating systems or network services of the client devices; and/or,
the server side is deployed in a cloud server and/or a local area network server.

In a fourth aspect, a server side device according to an embodiment of the present disclosure includes a processor and a memory, the memory is configured to store a program executable by the processor, and the processor is configured to read the program in the memory and execute following steps:
generating an application file and an access address of an application, and configuring transmission parameters of the application, where the application file includes a three-dimensional scenario model and logic codes of the application, and the transmission parameters are used for representing parameters required when the application is transmitted to a client device for being displayed;
generating a rendered stream according to the application file, where the rendered stream is associated with the access address, and the rendered stream is used for displaying the three-dimensional scenario model of the application in a manner of a video stream; and
sending the rendered stream to the client device based on the transmission parameters, where the client device includes a device for establishing communication connection with the server side device based on the access address.

As an optional implementation, the server side device includes a rendering system and a real-time communication server, and the real-time communication server is configured to establish communication connection between the rendering system and the client device based on a real-time communication technology; and the processor is configured to:
generate the application file of the application by using the rendering system, configure the transmission parameters of the application and upload the transmission parameters to the real-time communication server; and
generate the access address of the application by using the real-time communication server.

As an optional implementation, after the server side device generates the access address of the application by using the real-time communication server, the processor is further configured to:
upload the access address to a service platform, generate the rendered stream according to the application file, and send the rendered stream to the real-time communication server to be used for the client device to obtain the access address of the application from the service platform, to establish communication connection with the real-time communication server according to the access address; and
send the rendered stream to the client device through the real-time communication server.

As an optional implementation, the rendering system includes a three-dimensional rendering engine and a pixel streaming plug-in; and the processor is configured to:
generate the application file of the application by using the three-dimensional rendering engine; and
generate a pixel stream of the application based on the application file by using the three-dimensional rendering engine, and convert the pixel stream into the rendered stream by using the pixel streaming plug-in.

As an optional implementation, the rendering system includes a configuration interface; and the processor is configured to:
display a configuration option of the application on the configuration interface; and configure the transmission parameters of the application in response to transmission parameters input by a user in the configuration option of the configuration interface; or,
configure the transmission parameters of the application based on self-defined transmission parameters.

As an optional implementation, the real-time communication server includes a signaling service, and the signaling service is used for enabling interaction of a plurality of types of signaling between the server side device and the client device.

As an optional implementation, the real-time communication server includes a signaling service;
the signaling service is used for establishing communication connection between the rendering system and a client playing medium; or,
the signaling service is used for establishing communication connection between the real-time communication server and the client playing medium; or,
the signaling service is used for establishing a communication service between the client and the client playing medium.

As an optional implementation, the processor is configured to:
receive an interaction instruction sent by the client engine through the signaling service, and send the interaction instruction to the rendering system; and
respond to the interaction instruction through the rendering system, and send a response result to the client playing medium through the signaling service, where the client playing medium includes a player, the player is packaged based on Flutter language and supports a plurality of transmission protocols, and the player is applied to clients in different network environments.

As an optional implementation, the processor is configured to:
receive an interaction instruction sent by the client playing medium through the signaling service, and send the interaction instruction to the rendering system; and
send the interaction instruction to the rendering system by using the signaling service, respond to, by the rendering system, the interaction instruction and send a response result to the client playing medium through the signaling service, where the client playing medium includes a browser.

As an optional implementation, the signaling service includes a player service and a streamer service; and the processor is configured to:
send the interaction instruction to the client engine by using the player service, and send the interaction instruction to the signaling service through the client engine; and send the response result to the client playing medium by using the streamer service, where the client playing medium includes the player; or,
send the interaction instruction to the signaling service by using the player service; and send the response result to the client playing medium by using the streamer service, where the client playing medium includes the browser.

As an optional implementation, the application file further includes interaction logic codes, the rendered stream further includes a UI interaction interface, and the interaction logic codes are used for generating the UI interaction interface; and
after the playing and displaying is performed on the received rendered stream through the client playing medium, the processor is further configured to:
receive an operation instruction sent by the client playing medium; and
execute a corresponding operation according to the operation instruction, and send an operated UI interaction result to the client playing medium.

As an optional implementation, the server side device further includes a material warehouse; and the processor is further configured to:
upload the application file to the material warehouse, and generate a corresponding rendered stream according to the application file stored in the material warehouse.

As an optional implementation, the transmission parameters include a startup mode, and the startup mode is used for representing a maximum number of clients accessing the same three-dimensional rendering scenario of the application; and the processor is configured to:
configure the startup mode of the application, such that the same three-dimensional rendering scenario of the application is able to be accessed by a plurality of clients, and the plurality of clients are unable to operate a same element in the three-dimensional rendering scenario simultaneously.

In a fifth aspect, a client device according to an embodiment of the present disclosure includes a processor and a memory, the memory is configured to store a program executable by the processor, and the processor is configured to read the program in the memory and execute following steps:
obtaining an access address of an application, and establishing communication connection with a server side according to the access address, where the access address is associated with a rendered stream of the application, and the rendered stream is used for displaying a three-dimensional scenario model of the application in a manner of a video stream; and
receiving the rendered stream associated with the access address sent by a server side device, and performing playing and displaying on the received rendered stream through a client playing medium.

As an optional implementation, the processor is further configured to:
obtain a resource parameter set, where the resource parameter set includes at least one resource parameter, and the resource parameter is used for representing an operation state of the client device;
perform, in a case that the resource parameter set meets a first set condition, image enhancement processing on the rendered stream to obtain an enhanced video stream; and
perform playing and displaying on the enhanced video stream through the client playing medium.

As an optional implementation, the resource parameter set includes a stream pushing manner of a rendered stream and a network speed; and the first set condition includes:
a current network speed of the client device is less than or equal to a set network speed threshold; and/or,
a stream pushing manner of a rendered stream received by the client device at this time does not meet a preset requirement.

As an optional implementation, the stream pushing manner includes a resolution of a rendered stream; and the first set condition includes:
a resolution of a rendered stream received by the client device at this time is lower than or equal to a resolution of a rendered stream received last time.

As an optional implementation, the resource parameter set includes a network card configuration, and in a case that the resource parameter set meets the first set condition, the processor is configured to:
determine a hardware resource used for image enhancement processing according to whether the network card configuration includes a discrete graphics card and an integrated graphics card; and
perform image enhancement processing on the rendered stream by using the hardware resource to obtain an enhanced video stream.

As an optional implementation, the resource parameter set further includes a CPU resource; and the processor is configured to:
determine that the hardware resource used for image enhancement processing includes the integrated graphics card and the CPU resource in a case that the network card configuration includes the discrete graphics card and the integrated graphics card.

As an optional implementation, the resource parameter set includes a GPU resource and a video memory resource; and the processor is configured to:
determine that the hardware resource used for image enhancement processing includes the GPU resource in a case that the network card configuration does not have a condition of performing image enhancement processing in the integrated graphics card, the GPU resource is greater than or equal to a first threshold and the video memory resource is greater than or equal to a second threshold.

As an optional implementation, the resource parameter set further includes a GPU resource; and in a case that the resource parameter set meets the first set condition, the processor is further configured to:
adjust an enhancement level of an image enhancement algorithm according to the GPU resource, and perform image enhancement processing on the rendered stream by using the adjusted image enhancement algorithm, where the enhancement level is used for representing an intensity of image enhancement.

As an optional implementation, the processor is further configured to:
notify the server side to adjust the transmission parameters of the application in a case of monitoring that the resource parameter set meets the first set condition; or,
notify the server side to adjust the transmission parameters of the application in a case of monitoring that the resource parameter set meets the first set condition and meets a second set condition, where the second set condition includes: the resource parameters in the resource parameter set reach peak values, where one of the resource parameters corresponds to one of the peak values; or, a network speed in the resource parameter set is less than or equal to a network speed threshold.

As an optional implementation, the transmission parameters include a resolution of the rendered stream.

As an optional implementation, in a case that the resource parameter set meets the first set condition, the processor is configured to:
perform stream decoding on the rendered stream to obtain a decoded video stream, and perform image enhancement processing on the decoded video stream to obtain an enhanced video stream.

As an optional implementation, the client is deployed on client devices in different network environments, and the network environments are used for representing operating systems or network services of the client devices; and/or,
the server side is deployed in a cloud server and/or a local area network server.

In a sixth aspect, an embodiment of the present disclosure further provides a computer storage medium, storing a computer program thereon, where the program, when executed by a processor, is used for implementing the steps of the method in the second aspect or the third aspect above.

These or other aspects of the present disclosure will be clearer and more easily understood in the description of following embodiments.

### BRIEF DESCRIPTION OF FIGURES

In order to explain technical solutions in embodiments of the present disclosure more clearly, the following will briefly introduce the accompanying drawings that need to be used in the description of embodiments. Apparently, the accompanying drawings in the following description are only some embodiments of the present disclosure, and for those of ordinary skill in the art, on the premise of no creative labor, other accompanying drawings can be obtained from these accompanying drawings.

FIG. 1 is a schematic diagram of a real-time rendering system according to an embodiment of the present disclosure.

FIG. 2 is a diagram of a packaging setting interface for a deployment package of a UE according to an embodiment of the present disclosure.

FIG. 3A to FIG. 3C are schematic diagrams of an operation interface for accessing a rendering system according to an embodiment of the present disclosure.

FIG. 4A to FIG. 4B are schematic diagrams of a configuration interface according to an embodiment of the present disclosure.

FIG. 5 is a schematic diagram of an effect of displaying a rendered stream of an application on a client according to an embodiment of the present disclosure.

FIG. 6 is a schematic diagram of interaction of a client connecting with a real-time rendering system according to an embodiment of the present disclosure.

FIG. 7 is an implementation flow diagram of dynamic deployment of a client according to an embodiment of the present disclosure.

FIG. 8 is an implementation flow diagram of an image enhancement service according to an embodiment of the present disclosure.

FIG. 9 is an implementation flow diagram of a real-time rendering method according to an embodiment of the present disclosure.

FIG. 10A to FIG. 10B are operation interfaces of displaying rendered streams by client playing media according to an embodiment of the present disclosure.

FIG. 11 is an implementation flow diagram of a real-time rendering method according to an embodiment of the present disclosure.

FIG. 12 is a schematic diagram of a server side device according to an embodiment of the present disclosure.

FIG. 13 is a schematic diagram of a client device according to an embodiment of the present disclosure.

### DETAILED DESCRIPTION

In order to make the objects, technical solutions and advantages of the present disclosure clearer, the present disclosure will be further described in detail in combination with the accompanying drawings below. Apparently, the described embodiments are only part of embodiments of the present disclosure, not all of them. Based on embodiments of the present disclosure, all other embodiments obtained by those of ordinary skill in the art without creative work shall fall within the protection scope of the present disclosure.

In embodiments of the present disclosure, the term “and/or” describes the association relationship of associated objects, which represents that there can be three kinds of relationships, for example, A and/or B can represent that there are three kinds of situations: A alone, A and B at the same time, and B alone. The character “/” universally indicates that associated objects are in an “or” relationship.

Application scenarios described in embodiments of the present disclosure are to more clearly illustrate the technical solutions of embodiments of the present disclosure, and do not constitute a limitation on the technical solutions provided by embodiments of the present disclosure. It is known to those ordinarily skilled in the art that with the appearance of new application scenarios, the technical solutions provided by embodiments of the present disclosure are also suitable for similar technical problems. In the description of the present disclosure, unless otherwise stated, “plurality of” means two or more.

With the increasing maturity of the 5G technology, the continuous upgrading of technologies such as Artificial Intelligence (AI), Internet of Things (IoT) and cloud computing, and various possibilities in the metaverse era, three-dimensional rendering scenarios are very widely applied in related fields such as digital twins and visualization applications. The industry and enterprise development also has higher and higher requirements for real-time three-dimensional rendering technologies, and more application scenarios require the simultaneous use of multiple ability combinations. The three-dimensional rendering scenarios can use three-dimensional rendering engines to assist the development of service applications, but due to the virtualization properties of the three-dimensional rendering scenarios themselves, the actual development and construction process can be exceptionally cumbersome. Existing three-dimensional rendering services are generally deployed on terminals and require the development of corresponding three-dimensional rendering services based on network environment platforms of different terminals, making it impossible to achieve cross-platform deployment.

In order to solve the above technical problems, the present embodiment provides a real-time rendering system. A three-dimensional rendering task is executed through a server side, for example, the three-dimensional rendering task is achieved through a cloud server or a local area network server, and then a rendering result is transmitted to a client in the form of a video stream, namely transmitting a rendered stream to the client. The client is responsible for receiving and displaying the rendered stream, and rendering and processing tasks for three-dimensional scenarios are no longer dependent on a client device, but performed by a server at the server side. The client device just needs to receive the rendering result transmitted from the server at the server side and display the rendering result on a browser or other playing media in real time. As rendering tasks are distributed to the high-performance server side, the insufficient performance of the client device is avoided, complex three-dimensional scenarios are enabled to smoothly work on various devices, and meanwhile, real-time cooperative operations by a plurality of users may further be achieved. As the server at the server side has a powerful computing capacity, more complex illumination computing, shadow generation, texture details and post-processing effects may be supported, such that the three-dimensional scenarios are more lifelike in visual effect, bringing immersive experience to users. The server at the server side may process a great amount of scenario data and models, and supports high-performance rendering of scenarios such as large-scale cities, terrains and natural environments, which helps the users to better understand and analyze complex three-dimensional environments. As the rendering tasks are completed at the cloud, it is not necessary for the client device to have a powerful computing capacity, achieving cross-platform compatibility, including computers, mobile terminals, virtual reality devices and the like. Distributing the rendering tasks to the server at the server side lowers the performance requirement for the client device, such that the complex three-dimensional scenarios may smoothly work on various devices, lowering the performance requirement for the client. Server side rendering may remarkably lower the requirements for computing, internal memory and storage resources of the client device, and prolong the service life of the device, saving client resources. A rendering architecture based on the server side may perform application deployment and upgrading rapidly, making users obtain newest functions and optimization conveniently. The server at the server side may be elastically flexible according to actual requirements to effectively deal with the fluctuations of the quantity of users and computing tasks.

The real-time rendering system of the present embodiment performs the three-dimensional rendering tasks at the server side, and then transmits the rendering result to the client in the form of a video stream. This method allows for high-performance three-dimensional rendering at the server side and real-time transmission of the rendering result (rendered stream) to the client, providing users high-quality visual experience, lowering the requirement for the performance of the client device. As an actual rendering process is completed at the server side, the client device just needs to receive and display the rendered stream, such that even a low-performance device can also be used for viewing a high-quality three-dimensional rendering result, and it is suitable for various devices, including low-performance smart phones and tablets. In conclusion, the real-time rendering system architecture based on the server side has powerful functions and significant advantages, and can provide customers three-dimensional rendering services of high performance, high compatibility and high safety. In this way, the complex three-dimensional scenarios may smoothly work on various devices, and meanwhile, real-time cooperative operations by a plurality of users may further be achieved.

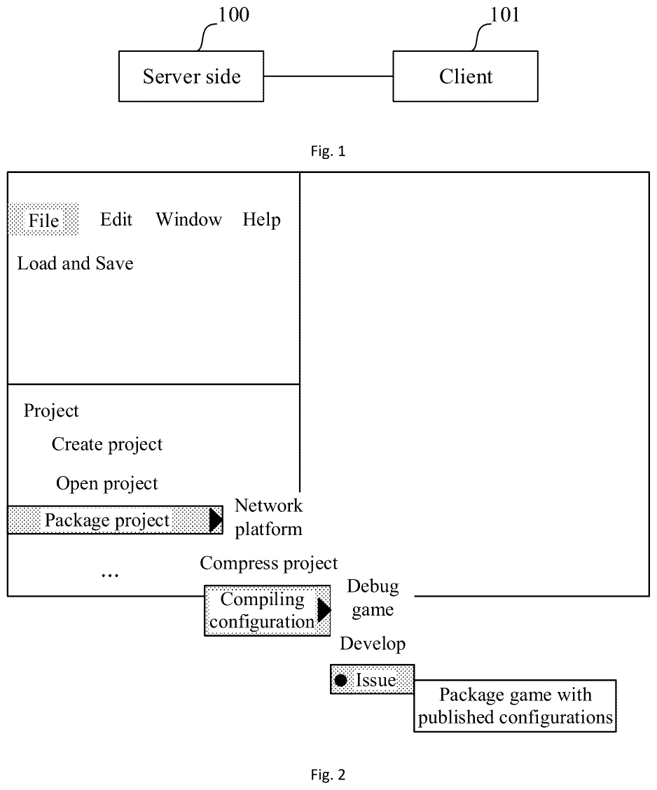

As shown in FIG. 1, a real-time rendering system provided by the present embodiment includes a server side 100 and a client 101.

Step 1, the server side generates an application file and an access address of an application, and configures transmission parameters of the application, the application file includes a three-dimensional scenario model and logic codes of the application, and the transmission parameters are used for representing parameters required when the application is transmitted from the server side to the client for being displayed.

Optionally, the transmission parameters in the present embodiment include but are not limited to: at least one or more of an application name, an application description, a path of an executable program, a stream pushing manner, a startup mode, maximum concurrency, a timeout duration, or an application cover image.

The stream pushing manner includes but is not limited to: a resolution of a rendered stream, a transmission protocol and other information.

The startup mode is used for representing a maximum number of clients accessing the same three-dimensional rendering scenario of an application. For example, the same three-dimensional rendering scenario of the application may be accessed by one or more clients. When the same three-dimensional rendering scenario of the application is able to be accessed by a plurality of clients, users corresponding to the plurality of clients can exist in the same three-dimensional rendering scenario, and the users of the plurality of clients may operate the same three-dimensional rendering scenario to achieve the effect of multi-person accessing and one-person operation.

The maximum concurrency is used for representing a maximum number of windows opened for displaying at the same time by the same application, where a rendered stream of the application may be displayed in one or more windows on the same client, or the rendered stream of the application may be displayed in windows of different clients, and the number of the windows is configured based on the maximum concurrency. The window may be understood as a window of a client playing medium.

The timeout duration is used for representing a maximum duration required for establishing connection between the client and a real-time communication (RTC) server.

Step 2, the server side generates a rendered stream according to the application file, the rendered stream is associated with the access address, and the rendered stream is used for displaying the three-dimensional scenario model of the application in a manner of a video stream.

Step 3, the client obtains the access address of the application, establishes communication connection with the server side according to the access address, receives the rendered stream sent by the server side based on the transmission parameters, and performs playing and displaying on the received rendered stream through a client playing medium.

In some embodiments, the server side in the present embodiment is deployed in a cloud server and/or a local area network server, the client in the present embodiment is deployed on client devices in different network environments, and the network environments are used for representing operating systems or network services of the client devices.

Optionally, the network environments include but are not limited to: one or more of Android, iOS, Window, and Web, which are not limited too much in the present embodiment.

During implementation, a server side device in the present embodiment includes a cloud server/a local area network server. The real-time rendering system in the present embodiment realizes a three-dimensional rendering task of the application through the cloud server/local area network server. The client in the present embodiment is located on the client device, and the client device includes but is not limited to a computer, a mobile phone, an IPAD and other terminals. The present embodiment may support the client devices in the different network environments (cross-platform) to receive and display the rendered stream.

In some embodiments, the server side in the present embodiment includes a rendering system and an RTC server, and the RTC server is configured to establish communication connection between the rendering system and the client based on an RTC technology; and the server side is configured to:
generate the application file of the application by using the rendering system, configure the transmission parameters of the application, and upload the transmission parameters to the RTC server; and generate the access address of the application by using the RTC server.

In some embodiments, after the server side generates the access address of the application by using the RTC server, following flows are further executed for the client to obtain the access address.

The server side uploads the access address to a service platform, and the server side generates the rendered stream according to the application file and sends the rendered stream to the RTC server.

The client obtains the access address of the application from the service platform, establishes communication connection with the RTC server according to the access address, and receives the rendered stream sent by the RTC server.

During implementation, the rendering system generates the application file of the application first, then configures the transmission parameters of the application and uploads the transmission parameters to the RTC server. After receiving the transmission parameters, the RTC server generates the access address of the application and feeds the access address back to the rendering system. The rendering system uploads the access address fed back by the RTC server to the service platform so that the access address is visible for users, such that the client obtains the access address from the service platform, thus establishing the communication connection between the client and the RTC server, and the communication connection between the client and the rendering system is established through the RTC server. It should be noted that, as the RTC server is configured to transmit the rendered stream generated by the rendering system to the client for being played and displayed, the RTC server needs to configure transmission information of the rendered stream based on the transmission parameters uploaded by the rendering system.

It should be noted that, real-time communication (RTC) is a real-time communication technology, which is generally defined as a technology of transmitting media streams such as speeches and videos in networks in real time. This technology is mainly applied to the field of real-time communication. The RTC server in the present embodiment is a server constructed based on an RTC architecture, and the RTC server has following functions: (1) media transmission: the RTC server is responsible for transmission and forwarding of audio and video media to ensure efficient transfer of real-time data; (2) signaling processing: the RTC server processes signaling interaction between clients, including connection establishment, control over a communication state, sending and receiving of communication-related instructions, etc.; (3) media processing: the RTC server may perform processing operations such as media encoding and decoding, remixing of media streams, and audio and video quality adjustment, to provide the better communication experience; (4) resource management: the RTC server manages resource allocation and scheduling of communication participants, including bandwidth management, network routing optimization and the like, to provide stable and high-quality real-time communication.

In some embodiments, the rendering system in the present embodiment includes a three-dimensional rendering engine and a pixel streaming plug-in; and the server side is configured to:
generate the application file of the application by using the three-dimensional rendering engine; and
generate a pixel stream of the application based on the application file by using the three-dimensional rendering engine, and convert the pixel stream into the rendered stream by using the pixel streaming plug-in.

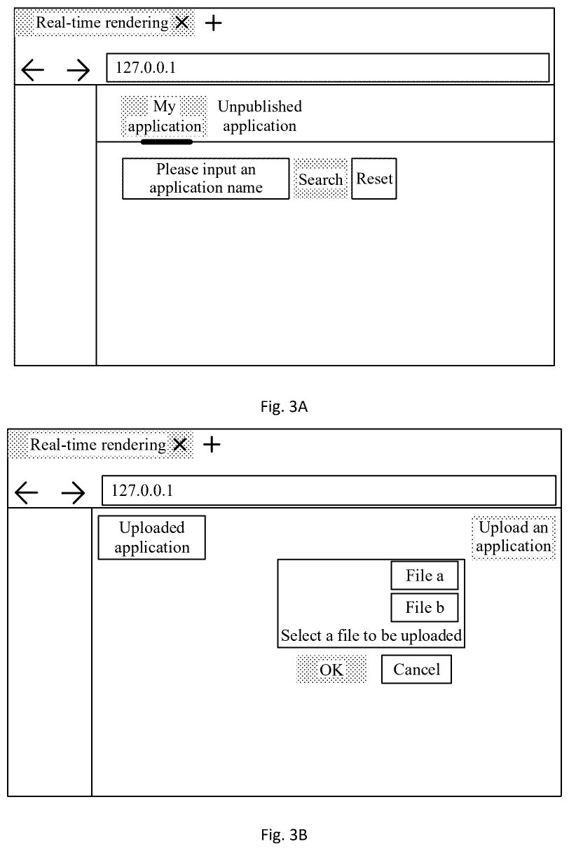

During implementation, the pixel stream of the application may be generated by using the three-dimensional rendering engine UE (unreal engine) and the pixel streaming plug-in, achieving modification conversion from the pixel stream to the rendered stream and loading of a deployment package (application file). The pixel stream is understood as a two-dimensional pixel data representation of the three-dimensional scenario model. The rendered stream is used for displaying the three-dimensional scenario model of the application in a manner of a video stream, and transmitting the three-dimensional scenario model in the manner of the video stream to the client playing medium for being displayed. The deployment package represents the application file in the present embodiment. Taking the three-dimensional rendering engine UE as an example, as shown in FIG. 2, the present embodiment provides a diagram of a packaging setting interface for the deployment package of the UE, and a specific packaging flow of the deployment package is as follows.

First, project engineering is imported through an engineering directory, and the engineering has included, in default, UE blueprint codes and a resource map which are written and well debugged. The blueprint codes represent the logic codes executed by the application, and the resource map represents the three-dimensional scenario model of the application.

Then, the project engineering operates, whether various functional modules of the project engineering normally operate is tested, a compiling configuration is set according to project conditions. If the project is a debugging project, the compiling configuration is set as “develop”, and if the project is an online project, the compiling configuration is set as “issue”. Then whether a platform has provided support is checked, at the same time, a map and a mode are set. Whether a GameMode is correctly set is checked, whether a main level is correctly set is checked, whether GameInstance (if any) is correctly set is checked, then project packaging is carried out. A packaged product is integrated into a zip, so far, a deployment package of a uniform format and with an access address URL is generated.

It should be noted that, the application file may not be rendered by using the three-dimensional rendering engine until the application is launched. After the application is launched, the rendered stream may be generated through the three-dimensional rendering engine and the pixel streaming plug-in. A final result of rendering of each frame is encoded, H.264 video compression is used to package video frames into a media stream which is sent to the RTC server, and the RTC server may transmit the generated media stream to one or more clients through direct peer-to-peer connection (bidirectional connection), which can achieve the interaction effect that a plurality of persons share a view angle and one person conducts operations.

In some embodiments, the rendering system in the present embodiment includes a configuration interface; and the server side is configured to:
display a configuration option of the application on the configuration interface; and configure the transmission parameters of the application in response to transmission parameters input by a user in the configuration option of the configuration interface; or,
configure the transmission parameters of the application based on self-defined transmission parameters.

The present embodiment provides two configuration manners, one is that the user may perform self-defined configuration on the transmission parameters on the configuration interface, and the other is automatic configuration based on the self-defined transmission parameters, for example, configuration is performed by using a default configuration manner. The user may select the configuration manner according to actual requirements, which is not limited too much in the present embodiment.

During implementation, the generated application file may be imported in the rendering system, then configuration of the transmission parameters is performed on the application corresponding to the application file, and a specific implementation process is as follows.

Flow a), first, the well deployed rendering system is accessed (e.g., a local address http://127.0.0.1:8080), and the rendering system is accessed through a browser.

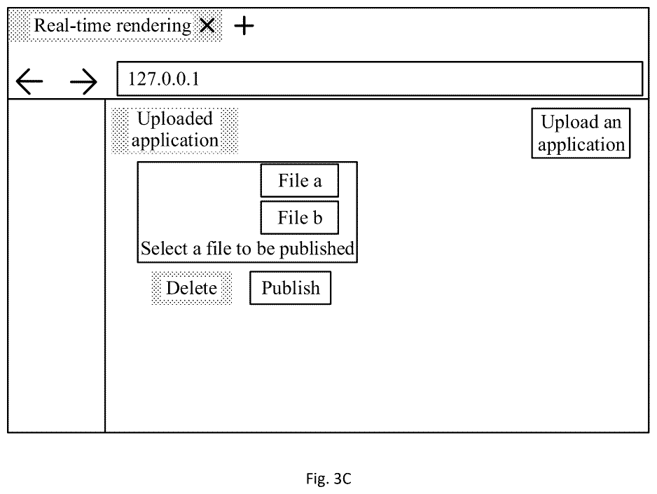

As shown in FIG. 3A to FIG. 3C, the present embodiment provides schematic diagrams of an operation interface for accessing the rendering system. By clicking on a label “unpublished application” in the page of FIG. 3A, an application uploading interface as shown in FIG. 3B is entered. By clicking on a button “upload an application” at the upper right corner, a file selection prompt box is entered. An application file to be uploaded is selected, and the application file is uploaded by clicking on an OK button. It is required that the application file is packaged in a zip format, and all application files are included under the top-level directory. As shown in FIG. 3C, uploaded application files may further be searched by clicking on a search box at the upper left corner. The application file may be deleted by clicking on a delete button under an application operation bar. A “publish” function button is located under the application operation bar, and an application may be published by clicking on the publish button. It should be noted that, the unpublished application refers to an application visible to a developer, edition operations such as configuration, modification and deletion may be performed on the transmission parameters of the application, any the application file of the application may also be edited. The published application, namely “my application”, refers to an application which cannot be edited by the developer, but the published application is still visible to the developer and invisible to users at the moment.

Flow b), the transmission parameters are configured through the rendering system.

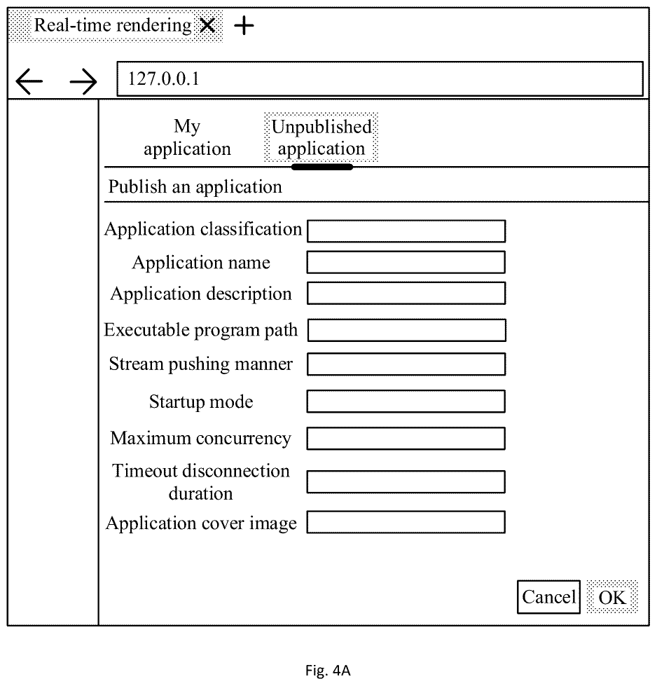

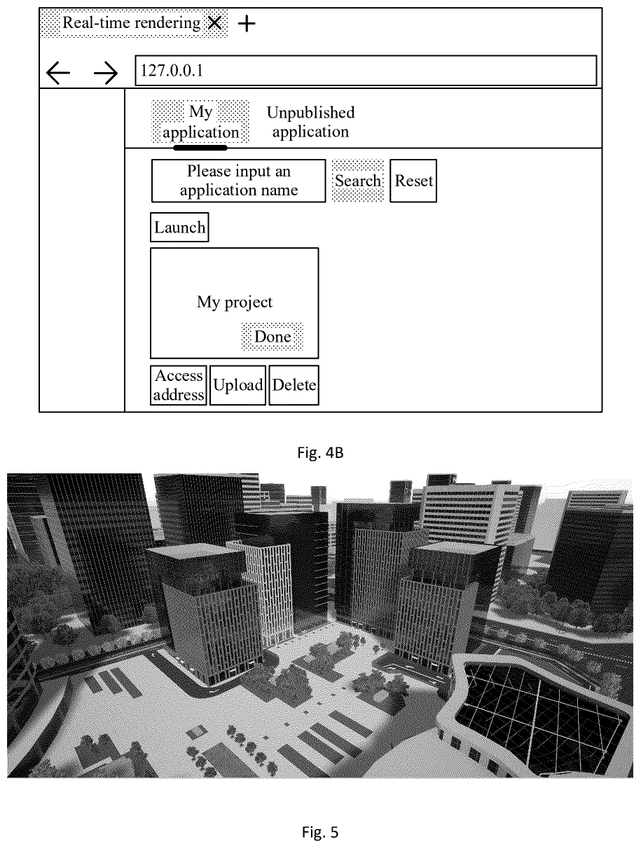

During implementation, uploaded applications are displayed in an “unpublished application” list. After finding an unpublished application, and entering the configuration interface by clicking on the publish button, a user may input the configured transmission parameters in the configuration option of the configuration interface. As shown in FIG. 4A to FIG. 4B, the present embodiment provides a schematic diagram of the configuration interface. A user inputs the transmission parameters in the configuration interface. For example, in step one, an application name is input, which has 20 character strings; in step two, an application description is input, which has 50 character strings; in step three, a path of an executable program is selected; in step four, a stream pushing manner is selected, which is 2K in default; in step five, a startup mode is selected, which is one-to-one in default; in step six, maximum concurrency is written; in step seven, a timeout duration is selected, where options “no limit” or “5 min” may be selected; and in step eight, an application cover image is uploaded. An OK button is clicked after filling and selecting are completed, to submit the transmission parameters of the application to the RTC server. After the transmission parameters configured by the user are confirmed, by clicking on “my application” on that configuration interface, the transmission parameters of the corresponding application and other information may be displayed. By clicking on a “link button” in an operation bar under the application, an access address of the application is generated, and the corresponding access address may be copied by clicking on the link button again. After the access address is copied, the application can only be accessed after a “launch” operation is performed on the application, the application is launched by clicking on a launch button in the application operation bar, and the access address copied in the last step is placed in a browser or a self-defined playing control plug-in for use. “Launch” the application refers to uploading the access address of the application to a service platform (e.g., an application store), for users to obtain the access address through that service platform, establishing communication connection with the server side.

In some embodiments, the transmission parameters include a startup mode, and the startup mode is used for representing a maximum number of clients accessing a same three-dimensional rendering scenario of the application; and the server side is configured to:
configure the startup mode of the application, such that the same three-dimensional rendering scenario of the application is able to be accessed by a plurality of clients, and the plurality of clients are unable to operate a same element in the three-dimensional rendering scenario simultaneously.

The rendered stream generated in the present embodiment may be operated in a browser, or in an independently-developed player, and supports a plurality of persons to share a view angle and one person to conduct operations. No program is required to be downloaded and installed additionally, as long as the access address of the application is imported into a browser or a self-defined client player. The dependence on hardware configurations and unnecessary time waste are reduced, and a necessary interaction system is reserved at the same time.

In some embodiments, the server side in the present embodiment includes the rendering system and the RTC server. The RTC server includes a signaling service, and the signaling service is used for enabling interaction of a plurality of types of signaling between the server side and the client; and/or, the client includes a client engine, and the client engine is configured to be connected with the signaling service and perform interaction of a plurality of types of signaling with the signaling service.

As the RTC server of the server side in the present embodiment develops the signaling service, transmission interaction of the a plurality of types of signaling may be enabled through the signaling service, so that no limitation is made on the network environment and the signaling, a cross-platform rendering service for clients of different platforms may be provided, the a plurality of types of signaling are compatible through the connection between the signaling service of the server side and the client engine of the client, the interaction of different types of signaling is enabled, and thus the rendering system in the present embodiment achieves the effects of cross-platform performance and compatibility.

It should be noted that, the signaling service in the present embodiment is mainly used for signaling interaction, while the transmission of the rendered stream is executed by an agency service of the RTC server instead of being executed by the signaling service. In the present embodiment, transmission of the rendered stream and transmission of the signaling are executed using different services, and thus the normal viewing experience of users is not affected in the process of executing signaling interaction, increasing a response speed of signaling interaction and improving the viewing experience of the users.

In some embodiments, the RTC server includes the signaling service; and the signaling service is used for executing any one or more of the following.
(1) The signaling service is used for establishing communication connection between the rendering system and the client playing medium.

During implementation, the signaling service may provide the connection between the rendering system and the client playing medium. Optionally, when the client playing medium is a browser, the signaling service establishes the connection between the browser and the RTC server, and the connection between the browser and the rendering system is established through the RTC server. When the client playing medium is a player, the signaling service establishes the connection between the player and the client engine first, and then establishes the connection between the player and the RTC server, and the connection between the player and the rendering system is established through the RTC server.
(2) The signaling service is used for establishing communication connection between the RTC server and the client playing medium.

During implementation, the signaling service may provide the connection between the RTC server and the client playing medium. Optionally, when the client playing medium is a browser, the signaling service establishes the connection between the browser and the RTC server. When the client playing medium is a player, the signaling service establishes the connection between the player and the client engine first, and then establishes the connection between the player and the RTC server.
(3) The signaling service is used for establishing a communication service between the client and the client playing medium.

During implementation, the signaling service may provide the connection between the client and the client playing medium. When the client playing medium is a player, the signaling service establishes the connection between the player and the client engine first, and establishes the connection between the client and the player through the client engine.

Optionally, the player in the present embodiment is packaged based on Flutter language and supports a plurality of transmission protocols, and the player may be applied to clients in different network environments. As the player is packaged using the Flutter language, the player may operate in different network environments, and a good cross-platform (Android, iOS, Window, Web, etc.) capacity is attained by means of the cross-platform characteristic of Flutter.

During implementation, after the rendering system publishes and launches the application, namely uploading the transmission parameters to the RTC server and uploading the access address to the service platform, the rendering system may start the three-dimensional rendering engine and the pixel streaming plug-in, to generate the rendered stream of the application, establish the communication connection with the RTC server and start to send the rendered stream to the RTC server. After that, the RTC server is connected to the signaling service, representing that the signaling service is ready for accepting a new connection; and the access address is imported after a client program is started, and then the client program may be automatically connected to the signaling service, establishing the connection between the client and the signaling service.

Optionally, a signaling service module uses the nodeJs development language+the express framework to realize relevant functions. The pixel streaming plug-in and the player communicate with each other through WEBSOCKET and the signaling service. The signaling service achieves information interaction and the implementation of service logics. The signaling service provides the client an HTML page including a player widget and/or control codes written with JavaScript.

In some embodiments, the client playing medium includes the browser; and the server side is configured to:
in a case that the client in response to an interaction instruction executed by a user on the browser, sends the interaction instruction to the signaling service, send the interaction instruction to the rendering system by using the signaling service, and respond to, by the rendering system, the interaction instruction and send, by the rendering system, a response result to the browser through the signaling service.

During implementation, the communication connection between the browser and the RTC server is established through the signaling service, such that the interaction instruction received by the browser is forwarded to the RTC server through the signaling service and then sent by the RTC server to the rendering system for response, the response result is returned, and the RTC server sends the response result to the browser through the signaling service.

In some embodiments, the signaling service includes a player service and a streamer service; and the client playing medium includes the browser, and the server side is configured to:
send the interaction instruction to the signaling service by using the player service; and send the response result to the browser by using the streamer service.

During implementation, an overall connection flow of real-time rendering in the browser is as follows.

When a user starts a rendered stream service, namely after the user obtains the access address, the signaling service may establish a direct link between the client browser and an RTC agency server. Once the connection is successfully established, the RTC server may directly transmit the rendered stream to the browser, or the rendered stream is directly sent to a WebRTC agency by a Web terminal playing container of the client through a JavaScript environment of the page, and then relayed back to the three-dimensional rendering engine. Even after the rendered stream starts to be played, the signaling service still maintains the connection with the browser and the RTC server, so that the signaling service can kick the user out of the streamer service when required and process disconnection initiated by the browser.

In some embodiments, the client includes the client engine, the client playing medium includes the player, the player is packaged based on the Flutter language and supports a plurality of transmission protocols, and the player is applied to clients in different network environments.

In response to an interaction instruction executed by a user on the player, the client sends the interaction instruction to the signaling service through the client engine; and the signaling service sends the interaction instruction to the rendering system, and the rendering system responds to the interaction instruction and sends a response result to the player through the signaling service.

During implementation, the communication connection between the player and the client engine is established through the signaling service, the interaction instruction received by the player is sent to the signaling service through the client engine, the signaling service forwards the interaction instruction to the rendering system for response through the RTC server, the rendering system returns the response result, and the RTC server sends the response result to the player through the signaling service.

In some embodiments, the signaling service includes a player service and a streamer service; and the client playing medium includes the player, and the server side is configured to:
send the interaction instruction to the client engine by using the player service, and send the interaction instruction to the signaling service through the client engine; and send the response result to the player by using the streamer service.

As an independent service module of the RTC server, the signaling service in the present embodiment is mainly responsible for communication between the pixel streaming plug-in and the player, the setting of the transmission parameters of the application, and the control over service logics.

During implementation, the player in the present embodiment is a cross-platform playing control plug-in packaged by the Flutter language of the client, this player not only attains a good cross-platform (Android, iOS, Window, Web, etc.) capacity by means of the cross-platform characteristic of Flutter, but also achieves connection and display of the rendered stream under a multi-protocol (x264/RTSPReal (Time Streaming Protocol), etc.) format due to the fact that the lower layer is connected with a self-defined rendered stream player and a signaling connection component. Meanwhile, through the connection of an independently-developed signaling component (client engine) with the signaling service and the RTC server, a plurality of types of signaling in a signaling processing service and an RTC service are compatible, the same cross-platform performance and compatibility effect as the browser is achieved, the performance and reliability are improved, and the effect is more remarkable especially in an offline scenario.

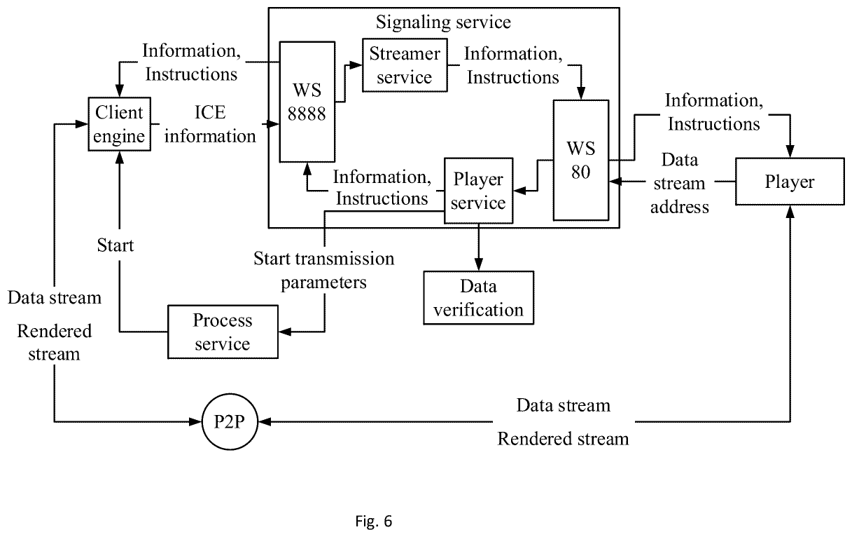

As shown in FIG. 6, the present embodiment provides a schematic diagram of interaction of a client connecting with a real-time rendering system. The signaling service includes a player service and a streamer service, and after being started, the signaling service monitors a port 8888, a port 80 and a port HTTP80 respectively. The player is opened, the access address of the rendered stream is input, the player loads the access address. After receiving a request from the client, the player service performs service verification on request data, and after the data pass the verification, a process service may be called to start the client engine. After the client engine is successfully started, Internet communications engine (ICE) information may be sent to the port 8888 monitored by WS, the streamer service performs relevant service logic processing on the received information and then sends the processed information to the player. Based on the WEBRTC protocol, the player and the client may establish a P2P link. Signaling related to user operations received by the player is sent to the client through the player service, and a response of the client may be sent to the player through the streamer service. So far, the client and the server side realize information communication.

In some embodiments, the application file further includes interaction logic codes, the rendered stream further includes a UI interaction interface, and the interaction logic codes are used for generating the UI interaction interface; and after the playing and displaying is performed on the received rendered stream through the client playing medium, the present embodiment further executes the following steps.

In response to an operation instruction of a user on the UI interaction interface, the client playing medium sends the operation instruction to the server side; and the server side executes a corresponding operation according to the operation instruction and sends an operated UI interaction result to the client playing medium.

During implementation, the client itself may not respond to the operation instruction, instead, the operation instruction is sent to the server side, and the server side responds to the operation instruction and then feeds a response result back to the client.

Optionally, the interaction logic codes include an interaction tool application programming interface (API).

It should be noted that, the rendered stream in the present embodiment is a rendered stream of a twin application, namely an underlying application, while the UI interaction interface is an interaction interface at the upper layer of the application, and the design of the UI interaction interface and the generation of the rendered stream may be executed independently, which is not limited too much in the present embodiment.

In some embodiments, the server side in the present embodiment further includes a material warehouse; and the server side is further configured to:
upload the application file to the material warehouse, and generate a corresponding rendered stream according to the application file stored in the material warehouse.

During implementation, the application file is uploaded to the material warehouse, a developer may directly extract the application file from the material warehouse, omitting a step of generating the application file. The application file is directly reused to generate the corresponding rendered stream, and the rendering efficiency is improved.

During implementation, after the transmission parameters of the application are configured, an application scenario model and the interaction tool API included in the application file may be uploaded to the associated material warehouse for performing uniform management and issuance. It should be noted that, the interaction tool API in the present embodiment is obtained based on the UI interaction interface involved in the application scenario model. When the access address and the interaction tool API of the configured application need to be used, since the access address of the application has been configured in the rendering system, by inputting or importing the access address to the browser and a self-defined playing control plug-in (i.e., player), clients of respective platforms may show the rendered stream at the clients of a plurality of platforms by accessing the access address URL of the rendered stream. As shown in FIG. 5, the present embodiment provides a schematic diagram of an effect of displaying the rendered stream of the application on the client.

In some embodiments, the client in the present embodiment can not only receive the rendered stream transmitted by the server side and play the rendered stream through the playing medium, but also perform image enhancement processing on the rendered stream, and further feed resource parameters back to the server side, dynamically adjusting the transmission parameters of the application corresponding to the rendered stream. The client in the present embodiment may dynamically obtain an operation state of the client device, dynamically adjust various resource parameters and be synchronous in feedback with the server side, and thus server resources can be saved gradually, the client utilizing efficiency is improved, the cost input is lowered, and the output flexibility is enhanced.

After the server side packages, publishes and launches the application file of the application, the client obtains the access address of the application, and interacts with the rendering system through a media medium of the client. When the client starts the rendering flow, namely in the process that the client receives and plays the rendered stream, a scheduling and monitoring service may be started synchronously for monitoring the resource parameters of the client device in real time, to determine whether image enhancement processing is performed on the rendered stream.

In some embodiments, the client is further configured to:
obtain a resource parameter set of the client device, where the resource parameter set includes at least one resource parameter, and the resource parameter is used for representing an operation state of the client device;
perform, in a case that the resource parameter set meets a first set condition, image enhancement processing on the rendered stream to obtain an enhanced video stream; and
play the enhanced video stream through the client playing medium.

Optionally, the resource parameter set in the present embodiment includes but is not limited to: at least one or more of resource parameters such as a stream pushing manner, a network card configuration, a CPU resource, a GPU resource, a video memory resource, or a network speed.

Optionally, the first set condition in the present embodiment includes but is not limited to any one or more of the following: a current network speed of the client device is less than or equal to a set network speed threshold; or a stream pushing manner of a rendered stream received by the client device at this time does not meet a preset requirement.

During implementation, the resource parameter set includes the stream pushing manner of the rendered stream and the network speed; and the client is configured to:
manner (1), perform, if it is monitored that the current network speed is less than or equal to the set network speed threshold, image enhancement processing on the rendered stream to obtain the enhanced video stream;
manner (2), perform, if it is monitored that the stream pushing manner of the rendered stream received at this time does not meet the preset requirement, image enhancement processing on the rendered stream to obtain the enhanced video stream.

Optionally, the stream pushing manner includes a resolution, a transmission protocol of the rendered stream (media stream), etc.

During implementation, the stream pushing manner includes the resolution of the rendered stream; and the first set condition includes: the resolution of the rendered stream received by the client device at this time is lower than or equal to a resolution of a rendered stream received last time. If the resolution of the rendered stream received by the client device at this time is lower than or equal to the resolution of the rendered stream received last time, image enhancement processing is performed on the rendered stream to obtain the enhanced video stream.

During implementation, the above manner (1) and manner (2) may be implemented in combination, and specific implementations are not repeated here.

During implementation, the client may start the scheduling and monitoring service to monitor whether the resource parameters in the resource parameter set of the client meet the first set condition. When the first set condition is met, an enhancement service of the client is started. Optionally, in the present embodiment, the enhancement service may be composed through a super-resolution algorithm (Gan class) and allocated resources plus a called API. When it is monitored that a discrete graphics card and an integrated graphics card co-exist, a picture quality resolution of the client is increased through the integrated graphics card and computing power of a CPU. Similarly, when it is monitored that the discrete graphics card has redundant computing power, the resolution of the rendered stream of the server side may be further lowered through signaling interaction with the server side, picture quality improvement is performed through the redundant computing power of the client device, and dynamic deployment is completed.

During implementation, firstly, the client starts the scheduling and monitoring service, and this service calls a Nvidia GPU nvmIDeviceGetUtilizationRates (device, &utilization) interface, a network card interface GetAdaptersInfo and a performance collection interface PdhOpenQuery to obtain resource parameters such as a current network card configuration, resource occupation, GPU configurations and CPU occupation. Secondly, a current network speed is determined, whether the network speed is less than or equal to X (X is a network speed threshold which is set in advance) is determined, and if the network speed is greater than X, it is proved that a network bandwidth is sufficient and whether the enhancement service is to be started to perform image enhancement processing may be selected by oneself; and if the network speed is less than or equal to X, the rendering system is notified to lower the resolution of the rendered stream, then the resolution is determined according to the rendered stream obtained by the client; whether the resolution of the rendered stream is less than or equal to Y (Y is a resolution before adjustment) is determined, if the resolution of the rendered stream is greater than Y, the network speed determining stage is performed again, and if the resolution of the rendered stream is less than or equal to Y, a stage of determining the resource parameters such as the GPU is proceeded.

In some embodiments, the resource parameter set includes the network card configuration, and if the resource parameter set meets the first set condition, the client is configured to perform following steps a and b.

Step a, a hardware resource used for image enhancement processing is determined according to whether the network card configuration includes a discrete graphics card and an integrated graphics card.

Optionally, the resource parameter set further includes the CPU resource; and it is determined that the hardware resource used for image enhancement processing includes the integrated graphics card and the CPU resource if the network card configuration includes the discrete graphics card and the integrated graphics card.

During implementation, whether the client device includes the discrete graphics card and the integrated graphics card at the same time is determined first, and if the client device includes the discrete graphics card and the integrated graphics card at the same time, image enhancement processing at the client is performed in a mode of integrated graphics card+CPU.

Optionally, the resource parameter set further includes the GPU resource and the video memory resource; and the client is configured to:
determine that the hardware resource used for image enhancement processing includes the GPU resource if the network card configuration does not have a condition of performing image enhancement processing in the integrated graphics card, the GPU resource is greater than or equal to a first threshold and the video memory resource is greater than or equal to a second threshold.

During implementation, if the network card configuration does not have the condition of performing image enhancement processing in the integrated graphics card, whether remain of the GPU is greater than or equal to U (U is a first threshold which may be dynamically set according to the mass of the application) is determined, at the same time, whether remain of a video memory is greater than or equal to T (T is a second threshold which may be dynamically set according to the mass of the application) is determined, if any of the two is no, image enhancement processing is stopped, if the two are yes at the same time, an enhancement level of image enhancement processing is adjusted according to the GPU resource. Whether loop detection is required is determined after adjustment, if the loop detection is not required, this flow is ended, and if loop detection is required, a loop detection stage is preceded.

In some embodiments, the resource parameter set further includes the GPU resource; and if the resource parameter set meets the first set condition, the client is further configured to:
adjust an enhancement level of an image enhancement algorithm according to the GPU resource, and perform image enhancement processing on the rendered stream by using the adjusted image enhancement algorithm, where the enhancement level is used for representing an intensity of image enhancement.

During implementation, the enhancement level of the image enhancement algorithm of the client may be adjusted according to the GPU resource of the client device monitored by the client. When the GPU resource is monitored, a monitoring result is sent to the rendering system through the RTC server, and the rendering system adjusts the resolution of the rendered stream based on the monitoring result and sends the adjusted rendered stream to the client playing medium through the RTC server for being displayed.

Optionally, the image enhancement algorithm includes resolution enhancement, and/or, image detail enhancement, such as a super-resolution algorithm.

Step b, image enhancement processing is performed on the rendered stream by using the hardware resource to obtain an enhanced video stream.

In some embodiments, if the resource parameter set meets the first set condition, the client is configured to:
perform stream decoding on the rendered stream to obtain a decoded video stream, and perform image enhancement processing on the decoded video stream to obtain an enhanced video stream.

During implementation, when it is determined that the client needs to perform image enhancement processing, it is required to perform stream decoding on the rendered stream first to obtain the decoded video stream, and then perform image enhancement processing to obtain the enhanced video stream.

In some embodiments, the client is further configured to:
notify the server side to adjust the transmission parameters of the application if it is monitored that the resource parameter set meets the first set condition; or,
notify the server side to adjust the transmission parameters of the application if it is monitored that the resource parameter set meets the first set condition and meets a second set condition. Optionally, the transmission parameters include the resolution of the rendered stream.

The second set condition includes: the resource parameters in the resource parameter set reach peak values, where one of the resource parameters corresponds to one of the peak values; or, a network speed in the resource parameter set is less than or equal to a network speed threshold.

During implementation, the client starts the scheduling and monitoring service, performs stream decoding on the rendered stream first when the resource parameter set meets the first set condition (for example, it is determined that the current network speed is less than or equal to the set network speed threshold), and at the same time, determines whether image enhancement processing is started, if decoding succeeds and the scheduling and monitoring service feeds back that a condition of starting image enhancement processing is achieved (for example, it is monitored that the resolution of the rendered stream received at this time is lower than the resolution of the rendered stream received last time), image enhancement processing is started. If it is determined that image enhancement processing does not need to be started, the received rendered stream is directly sent to the player for being displayed.

In the present embodiment, when it is monitored that a network condition of the client device at present is not sufficient to support the rendered stream of the application, or server side resources are tight and require the client to perform collaborative rendering, while releasing part of the server side resources, the enhancement level of the image enhancement algorithm, for example, the enhancement level of resolution enhancement, may be determined according to a current hardware occupation situation. Considering actual use conditions and dynamic management of resources, the enhancement level of the image enhancement algorithm of the client is generally enhanced to a target resolution instead of a highest resolution. After the level is enhanced to the corresponding resolution, occupation situations of various hardware may be checked circularly and synchronously. When a case that the resource parameters reach the peak values occurs, it is fed back to the server side in time to perform information interaction, the resolution of the rendered stream output by the server side is adjusted reversely, and meanwhile, the image enhancement algorithm of the client is temporarily lowered or stopped, so that the goal of forward and reverse controllability can be achieved.

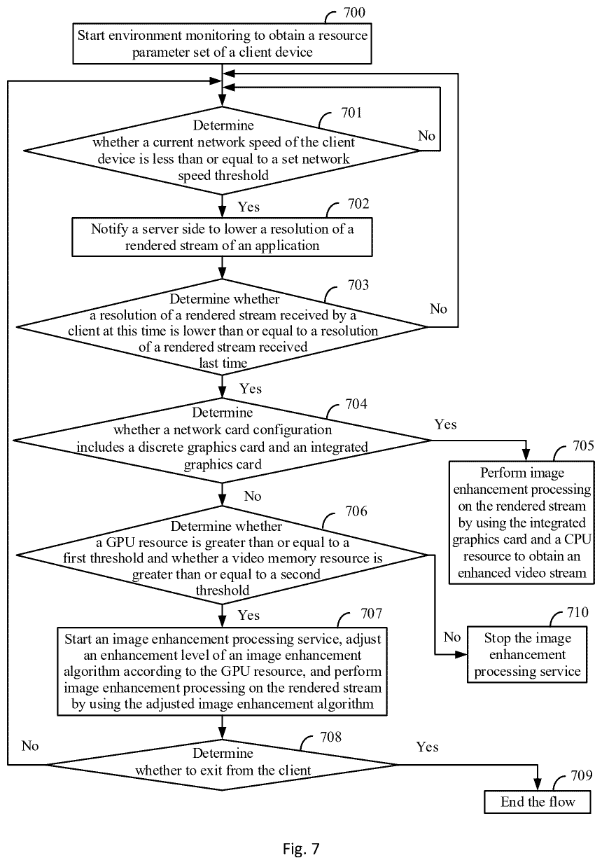

As shown in FIG. 7, the present embodiment provides an implementation flow of dynamic deployment of a client, which includes following steps.
Step 700, environment monitoring is started to obtain a resource parameter set of a client device.
Step 701, whether a current network speed of the client device is less than or equal to a set network speed threshold is determined, if the current network speed of the client device is less than or equal to the set network speed threshold, step 702 is executed, the current network speed of the client device is greater than the set network speed threshold, step 701 is executed.
Step 702, the server side is notified to lower a resolution of a rendered stream of an application.
Step 703, whether a resolution of a rendered stream received by a client at this time is lower than or equal to a resolution of a rendered stream received last time, if the resolution of the rendered stream received by the client at this time is lower than or equal to the resolution of the rendered stream received last time, step 704 is executed, the resolution of the rendered stream received by the client at this time is higher than the resolution of the rendered stream received last time, step 701 is executed.
Step 704, whether a network card configuration includes a discrete graphics card and an integrated graphics card is determined, if the network card configuration includes the discrete graphics card and the integrated graphics card, step 705 is executed, the network card configuration does not include the discrete graphics card and the integrated graphics card, step 706 is executed.
Step 705, image enhancement processing is performed on the rendered stream by using the integrated graphics card and a CPU resource to obtain an enhanced video stream.
Step 706, whether the GPU resource is greater than or equal to a first threshold and whether a video memory resource is greater than or equal to a second threshold are determined, if both are yes, step 707 is executed, otherwise, step 710 is executed.
Step 707, an image enhancement processing service is started, an enhancement level of an image enhancement algorithm is adjusted according to the GPU resource, and image enhancement processing is performed on the rendered stream by using the adjusted image enhancement algorithm.
Step 708, whether to exit from the client is determined, if yes, step 709 is executed, otherwise, step 701 is executed.
Step 709, the flow is ended.
Step 710, the image enhancement processing service is stopped.

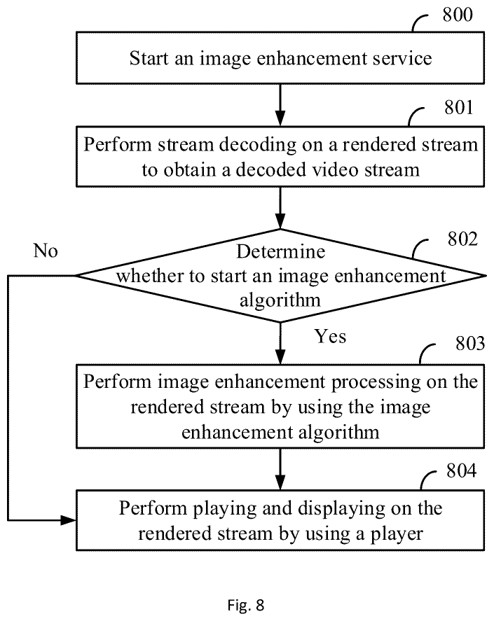

During implementation, when a scheduling service starts an image enhancement service of the client device, the image enhancement service of the client device may operate a flow itself. As shown in FIG. 8, the present embodiment provides an implementation flow of the image enhancement service, which includes following steps.
Step 800, an image enhancement service is started.
Step 801, stream decoding is performed on a rendered stream to obtain a decoded video stream.
Step 802, whether to start an image enhancement algorithm is determined, if yes, step 803 is executed, otherwise, step 804 is executed.

For example, whether the super-resolution algorithm is started is determined.
Step 803, image enhancement processing is performed on the rendered stream by using the image enhancement algorithm.

For example, format conversion super-resolution processing may be performed on the rendered stream.
Step 804, playing and displaying are performed on the rendered stream by using the player.

In the present embodiment, based on the three-dimensional rendering engine, the three-dimensional deployment package (application file) of the application is generated and imported into the rendering system, the transmission parameters are configured through the configuration interface of the rendering system, the access address URL of the rendered stream is generated, the URL is quickly issued to playing media (containers) of a plurality of client devices (terminals), the states of the client devices may be dynamically obtained at a client side through a scheduling and monitoring module, the image enhancement service at the client side is started in real time, and various transmission parameters as well as a solution of feedback synchronization with the server side are dynamically adjusted. The server resources can be saved gradually, the client utilizing efficiency is improved, the cost input is lowered, and the output flexibility is enhanced.

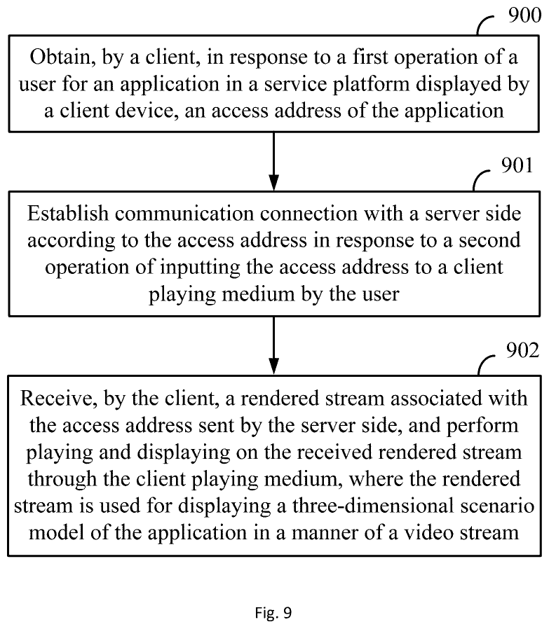

Based on the same inventive concept, an embodiment of the present disclosure further provides a real-time rendering method. As shown in FIG. 9, a specific implementation flow of the method includes following steps.
Step 900, in response to a first operation of a user for an application in a service platform displayed by a client device, a client obtains an access address of the application.

Optionally, the first operation includes but is not limited to clicking, long pressing, and other copying operations, which are used to copy the access address into a clipboard.
Step 901, communication connection with a server side is established according to the access address in response to a second operation of inputting the access address to a client playing medium by the user.

Optionally, the second operation includes but is not limited to the user pasting or importing the access address into an address bar of the client playing medium to access the server side.
Step 902, the client receives a rendered stream associated with the access address sent by the server side, and performs playing and displaying on the received rendered stream through the client playing medium, where the rendered stream is used for displaying a three-dimensional scenario model of the application in a manner of a video stream.

As an optional implementation, the client includes a client engine, the client playing medium includes a player, the player is packaged based on Flutter language and supports a plurality of transmission protocols, and the player is applied to clients in different network environments; and the method further includes:
sending, by the client, in response to an interaction instruction executed by the user on the player, the interaction instruction to the server side through the client engine, to be used for the server side to respond to the interaction instruction and send a response result to the player; and
displaying, by the player, the received response result.

As an optional implementation, the client playing medium includes a browser; and the method further includes:
sending, by the client, in response to an interaction instruction executed by the user on the browser, the interaction instruction to the server side, to be used for the server side to respond to the interaction instruction and send a response result to the browser; and
displaying, by the browser, the received response result.

As an optional implementation, the rendered stream further includes a UI interaction interface, and the method further includes:
sending, by the client playing medium, in response to an operation instruction of the user on the UI interaction interface, the operation instruction to the server side, to be used for the server side to execute a corresponding operation according to the operation instruction and send an operated UI interaction result to the client playing medium; and
displaying, by the client playing medium, the received UI interaction result.

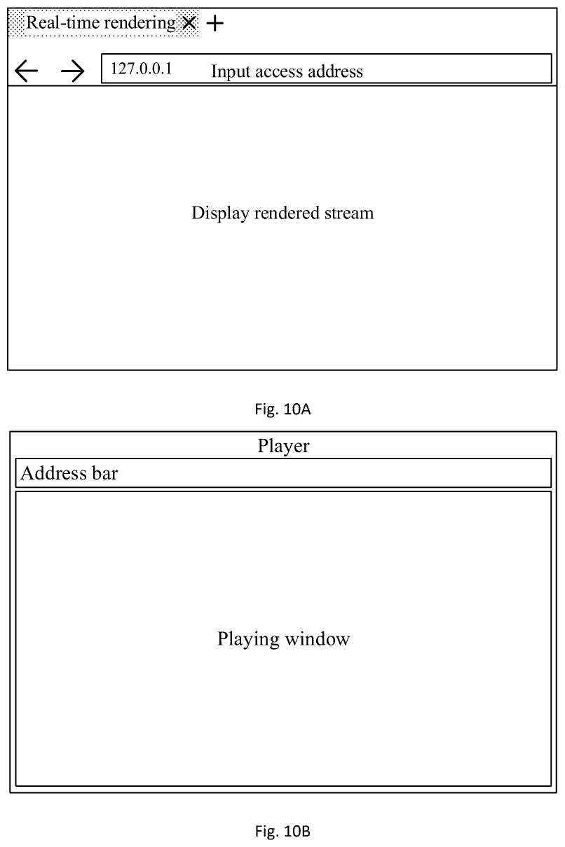

As shown in FIG. 10A to FIG. 10B, the present embodiment further provides operation interfaces of displaying rendered streams by client playing media. FIG. 10A is an operation interface of displaying a rendered stream by a browser. After a user inputs an access address into an address bar, the browser establishes connection with a server side and receives the rendered stream associated with the access address sent by the server side, and thus the rendered stream is displayed on the browser. FIG. 10B is an operation interface of displaying a rendered stream by a player. After a user inputs an access address into an address bar of the player, the player establishes connection with the server side and receives the rendered stream associated with the access address sent by the server side, and thus the rendered stream is displayed on the player.

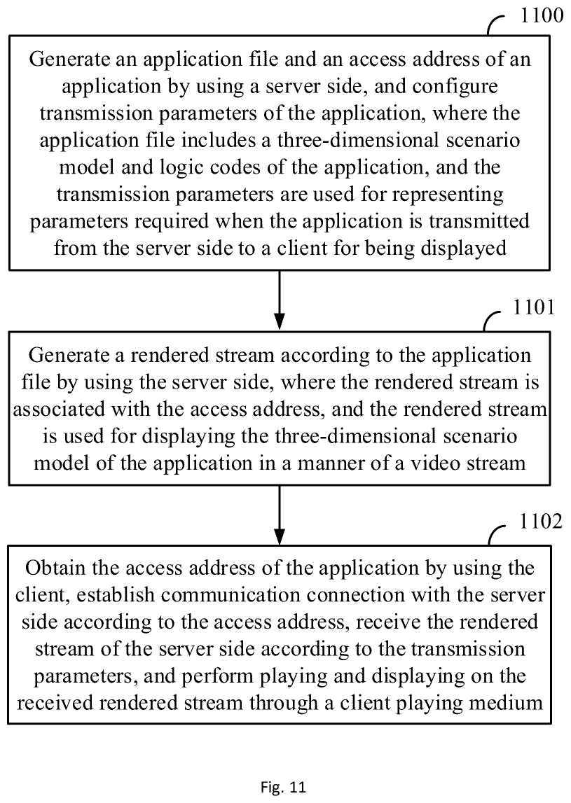

Based on the same inventive concept, an embodiment of the present disclosure further provides a real-time rendering method. As shown in FIG. 11, a specific implementation flow of the method is as follows.
Step 1100, an application file and an access address of an application are generated by using a server side, and transmission parameters of the application are configured, where the application file includes a three-dimensional scenario model and logic codes of the application, and the transmission parameters are used for representing parameters required when the application is transmitted from the server side to a client for being displayed.
Step 1101, a rendered stream is generated according to the application file by using the server side, where the rendered stream is associated with the access address, and the rendered stream is used for displaying the three-dimensional scenario model of the application in a manner of a video stream.
Step 1102, the access address of the application is obtained by using the client, communication connection with the server side is established according to the access address, the rendered stream of the server side is received according to the transmission parameters, and playing and displaying is performed on the received rendered stream through a client playing medium.

As an optional implementation, the server side includes a rendering system and a real-time communication RTC server, and the RTC server is configured to establish communication connection between the rendering system and the client based on an RTC technology;
the application file of the application is generated by using the rendering system, the transmission parameters of the application are configured, and the transmission parameters are uploaded to the RTC server; and
the access address of the application is generated by using the RTC server.

As an optional implementation, after the server side generates the access address of the application by using the RTC server, the following is further included:
the server side uploads the access address to a service platform, and the server side generates the rendered stream according to the application file and sends the rendered stream to the RTC server; and
the client obtains the access address of the application from the service platform, establishes communication connection with the RTC server according to the access address, and receives the rendered stream sent by the RTC server.

As an optional implementation, the rendering system includes a three-dimensional rendering engine and a pixel streaming plug-in;
the application file of the application is generated by using the three-dimensional rendering engine; and
a pixel stream of the application is generated based on the application file by using the three-dimensional rendering engine, and the pixel stream is converted into the rendered stream by using the pixel streaming plug-in.

As an optional implementation, the rendering system includes a configuration interface;
a configuration option of the application is displayed on the configuration interface; and the transmission parameters of the application are configured in response to transmission parameters input by a user in the configuration option of the configuration interface; or,
the transmission parameters of the application are configured based on self-defined transmission parameters.

As an optional implementation, the RTC server includes a signaling service, and the signaling service is used for enabling interaction of a plurality of types of signaling between the server side and the client; and/or,
the client includes a client engine, and the client engine is configured to be connected with the signaling service and perform interaction of a plurality of types of signaling with the signaling service.

As an optional implementation, the RTC server includes a signaling service;
the signaling service is used for establishing communication connection between the rendering system and the client playing medium; or,
the signaling service is used for establishing communication connection between the RTC server and the client playing medium; or,
the signaling service is used for establishing a communication service between the client and the client playing medium.

As an optional implementation, the client includes the client engine, the client playing medium includes a player, the player is packaged based on Flutter language and supports a plurality of transmission protocols, and the player is applied to clients in different network environments;
in response to an interaction instruction executed by a user on the player, the client sends the interaction instruction to the signaling service through the client engine; and
the signaling service sends the interaction instruction to the rendering system, and the rendering system responds to the interaction instruction and sends a response result to the player through the signaling service.

As an optional implementation, the client playing medium includes a browser;
in response to an interaction instruction executed by a user on the browser, the client sends the interaction instruction to the signaling service; and
the interaction instruction is sent to the rendering system by using the signaling service, and the rendering system responds to the interaction instruction and sends a response result to the browser through the signaling service.

As an optional implementation, the signaling service includes a player service and a streamer service; and the client playing medium includes a player:
the interaction instruction is sent to the client engine by using the player service, and the interaction instruction is sent to the signaling service through the client engine; and the response result is sent to the player by using the streamer service; or,
the client playing medium includes a browser:
the interaction instruction is sent to the signaling service by using the player service; and the response result is sent to the browser by using the streamer service.

As an optional implementation, the application file further includes interaction logic codes, the rendered stream further includes a UI interaction interface, and the interaction logic codes are used for generating the UI interaction interface; and
after the playing and displaying is performed on the received rendered stream through the client playing medium, the following is further included:
in response to an operation instruction of a user on the UI interaction interface, the client playing medium sends the operation instruction to the server side; and
the server side executes a corresponding operation according to the operation instruction, and sends an operated UI interaction result to the client playing medium.

As an optional implementation, the server side further includes a material warehouse;
the application file is uploaded to the material warehouse, and a corresponding rendered stream is generated according to the application file stored in the material warehouse.

As an optional implementation, the transmission parameters include a startup mode, and the startup mode is used for representing a maximum number of clients accessing a same three-dimensional rendering scenario of the application;
the startup mode of the application is configured, such that the same three-dimensional rendering scenario of the application is able to be accessed by a plurality of clients, and the plurality of clients are unable to operate a same element in the three-dimensional rendering scenario simultaneously.

As an optional implementation, the method further includes:
obtaining a resource parameter set of the client device, where the resource parameter set includes at least one resource parameter, and the resource parameter is used for representing an operation state of the client device;
performing, in a case that the resource parameter set meets a first set condition, image enhancement processing on the rendered stream to obtain an enhanced video stream; and
performing playing and displaying on the enhanced video stream through the client playing medium.

As an optional implementation, the resource parameter set includes a stream pushing manner of a rendered stream and a network speed; and the first set condition includes:
a current network speed of the client device is less than or equal to a set network speed threshold; and/or,
a stream pushing manner of a rendered stream received by the client device at this time does not meet a preset requirement.

As an optional implementation, the stream pushing manner includes a resolution of a rendered stream; and the first set condition includes:
a resolution of a rendered stream received by the client device at this time is lower than or equal to a resolution of a rendered stream received last time.

As an optional implementation, the resource parameter set includes a network card configuration, and in a case that the resource parameter set meets the first set condition, a hardware resource used for image enhancement processing is determined according to whether the network card configuration includes a discrete graphics card and an integrated graphics card; and image enhancement processing is performed on the rendered stream by using the hardware resource to obtain an enhanced video stream.

As an optional implementation, the resource parameter set further includes a CPU resource; and
it is determined that the hardware resource used for image enhancement processing includes the integrated graphics card and the CPU resource in a case that the network card configuration includes the discrete graphics card and the integrated graphics card.

As an optional implementation, the resource parameter set further includes a GPU resource and a video memory resource; and
it is determined that the hardware resource used for image enhancement processing includes the GPU resource in a case that the network card configuration does not have a condition of performing image enhancement processing in the integrated graphics card, the GPU resource is greater than or equal to a first threshold and the video memory resource is greater than or equal to a second threshold.

As an optional implementation, the resource parameter set further includes a GPU resource; and in a case that the resource parameter set meets the first set condition, the following is further included:
the client adjusts an enhancement level of an image enhancement algorithm according to the GPU resource, and performs image enhancement processing on the rendered stream by using the adjusted image enhancement algorithm, where the enhancement level is used for representing an intensity of image enhancement.

As an optional implementation, the method further includes:
notifying, by the client, the server side to adjust the transmission parameters of the application in a case of monitoring that the resource parameter set meets the first set condition; or,
notifying, by the client, the server side to adjust the transmission parameters of the application in a case of monitoring that the resource parameter set meets the first set condition and meets a second set condition, where the second set condition includes: the resource parameters in the resource parameter set reach peak values, where one of the resource parameters corresponds to one of the peak values; or, a network speed in the resource parameter set is less than or equal to a network speed threshold.

As an optional implementation, the transmission parameters include a resolution of the rendered stream.

As an optional implementation, in a case that the resource parameter set meets the first set condition, stream decoding is performed on the rendered stream to obtain a decoded video stream, and image enhancement processing is performed on the decoded video stream to obtain an enhanced video stream.

As an optional implementation, the client is deployed on client devices in different network environments, and the network environments are used for representing operating systems or network services of the client devices; and/or,
the server side is deployed in a cloud server and/or a local area network server.

Based on the same inventive concept, an embodiment of the present disclosure further provides a server side device. Since the server side device is a server side in the system in embodiments of the present disclosure and the principle of solving problems of the server side device is similar to that of the system, implementation of the server side device may refer to implementation of the system, and repetitions are omitted.

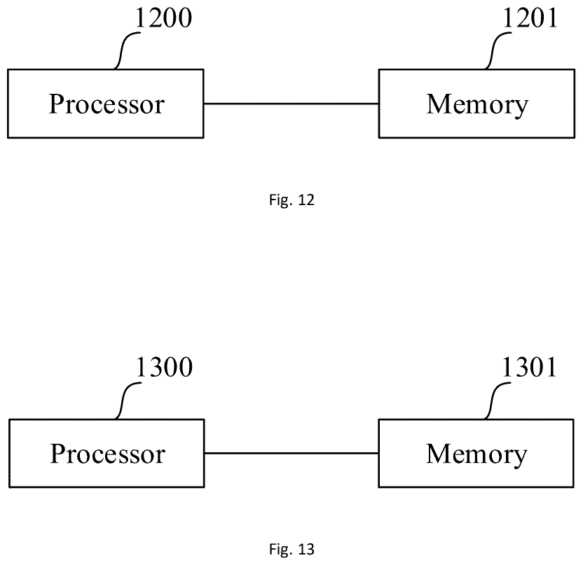

As shown in FIG. 12, the server side device includes: a processor 1200 and a memory 1201, where the memory 1201 is configured to store a program executable by the processor 1200, and the processor 1200 is configured to read the program in the memory 1201 and execute following steps:
generating an application file and an access address of an application, and configuring transmission parameters of the application, where the application file includes a three-dimensional scenario model and logic codes of the application, and the transmission parameters are used for representing parameters required when the application is transmitted to a client device for being displayed;
generating a rendered stream according to the application file, where the rendered stream is associated with the access address, and the rendered stream is used for displaying the three-dimensional scenario model of the application in a manner of a video stream; and
sending the rendered stream to the client device based on the transmission parameters, where the client device includes a device for establishing communication connection with the server side device based on the access address.

As an optional implementation, the server side device includes a rendering system and a real-time communication RTC server, and the RTC server is configured to establish communication connection between the rendering system and the client device based on an RTC technology; and the processor 1200 is configured to:
generate the application file of the application by using the rendering system, configure the transmission parameters of the application, and upload the transmission parameters to the RTC server; and
generate the access address of the application by using the RTC server.

As an optional implementation, after the server side device generates the access address of the application by using the RTC server, the processor 1200 is further configured to:
upload the access address to a service platform, generate the rendered stream according to the application file, and send the rendered stream to the RTC server to be used for the client device to obtain the access address of the application from the service platform, to establish communication connection with the RTC server according to the access address; and
send the rendered stream to the client device through the RTC server.

As an optional implementation, the rendering system includes a three-dimensional rendering engine and a pixel streaming plug-in; and the processor 1200 is configured to:
generate the application file of the application by using the three-dimensional rendering engine; and
generate a pixel stream of the application based on the application file by using the three-dimensional rendering engine, and convert the pixel stream into the rendered stream by using the pixel streaming plug-in.

As an optional implementation, the rendering system includes a configuration interface; and the processor 1200 is configured to:
display a configuration option of the application on the configuration interface; and configure the transmission parameters of the application in response to transmission parameters input by a user in the configuration option of the configuration interface; or,
configure the transmission parameters of the application based on self-defined transmission parameters.

As an optional implementation, the RTC server includes a signaling service, and the signaling service is used for enabling interaction of a plurality of types of signaling between the server side device and the client device.

As an optional implementation, the RTC server includes a signaling service;
the signaling service is used for establishing communication connection between the rendering system and a client playing medium; or,
the signaling service is used for establishing communication connection between the RTC server and a client playing medium; or,
the signaling service is used for establishing a communication service between the client and the client playing medium.

As an optional implementation, the processor 1200 is configured to:
receive an interaction instruction sent by the client engine through the signaling service, and send the interaction instruction to the rendering system; and
respond to the interaction instruction through the rendering system, and send a response result to the client playing medium through the signaling service, where the client playing medium includes a player, the player is packaged based on Flutter language and supports a plurality of transmission protocols, and the player is applied to clients in different network environments.

As an optional implementation, the processor 1200 is configured to:
receive an interaction instruction sent by the client playing medium through the signaling service, and send the interaction instruction to the rendering system; and
send the interaction instruction to the rendering system by using the signaling service, respond to, by the rendering system, the interaction instruction and send a response result to the client playing medium through the signaling service, where the client playing medium includes a browser.

As an optional implementation, the signaling service includes a player service and a streamer service; and the processor 1200 is configured to:
send the interaction instruction to the client engine by using the player service, and send the interaction instruction to the signaling service through the client engine; and send the response result to the client playing medium by using the streamer service, where the client playing medium includes the player; or,
send the interaction instruction to the signaling service by using the player service; and send the response result to the client playing medium by using the streamer service, where the client playing medium includes the browser.

As an optional implementation, the application file further includes interaction logic codes, the rendered stream further includes a UI interaction interface, and the interaction logic codes are used for generating the UI interaction interface; and
after the playing and displaying is performed on the received rendered stream through the client playing medium, the processor 1200 is further configured to:
receive an operation instruction sent by the client playing medium; and
execute a corresponding operation according to the operation instruction, and send an operated UI interaction result to the client playing medium.

As an optional implementation, the server side device further includes a material warehouse; and the processor 1200 is further configured to:
upload the application file to the material warehouse, and generate a corresponding rendered stream according to the application file stored in the material warehouse.

As an optional implementation, the transmission parameters include a startup mode, and the startup mode is used for representing a maximum number of clients accessing the same three-dimensional rendering scenario of the application; and the processor 1200 is configured to:
configure the startup mode of the application, such that the same three-dimensional rendering scenario of the application is able to be accessed by a plurality of clients, and the plurality of clients are unable to operate a same element in the three-dimensional rendering scenario simultaneously.

Based on the same inventive concept, an embodiment of the present disclosure further provides a client device. Since the client device is a client in the system in embodiments of the present disclosure and the principle of solving problems of the client device is similar to that of the system, implementation of the client device may refer to implementation of the system, and repetitions are omitted.

As shown in FIG. 13, the client device includes: a processor 1300 and a memory 1301, where the memory 1301 is configured to store a program executable by the processor 1300, and the processor 1300 is configured to read the program in the memory 1301 and execute following steps:
obtaining an access address of an application, and establishing communication connection with a server side according to the access address, where the access address is associated with a rendered stream of the application, and the rendered stream is used for displaying a three-dimensional scenario model of the application in a manner of a video stream; and
receiving the rendered stream associated with the access address sent by a server side device, and performing playing and displaying on the received rendered stream through a client playing medium.

As an optional implementation, the processor 1300 is further configured to:
obtain a resource parameter set, where the resource parameter set includes at least one resource parameter, and the resource parameter is used for representing an operation state of the client device;
perform, in a case that the resource parameter set meets a first set condition, image enhancement processing on the rendered stream to obtain an enhanced video stream; and
perform playing and displaying on the enhanced video stream through a client playing medium.

As an optional implementation, the resource parameter set includes a stream pushing manner of a rendered stream and a network speed; and the first set condition includes:
a current network speed of the client device is less than or equal to a set network speed threshold; and/or,
a stream pushing manner of a rendered stream received by the client device at this time does not meet a preset requirement.

As an optional implementation, the stream pushing manner includes a resolution of a rendered stream; and the first set condition includes:
a resolution of a rendered stream received by the client device at this time is lower than or equal to a resolution of a rendered stream received last time.

As an optional implementation, the resource parameter set includes a network card configuration, and in a case that the resource parameter set meets the first set condition, the processor 1300 is configured to:
determine a hardware resource used for image enhancement processing according to whether the network card configuration includes a discrete graphics card and an integrated graphics card; and
perform image enhancement processing on the rendered stream by using the hardware resource to obtain an enhanced video stream.

As an optional implementation, the resource parameter set further includes a CPU resource; and the processor 1300 is configured to:
determine that the hardware resource used for image enhancement processing includes the integrated graphics card and the CPU resource in a case that the network card configuration includes the discrete graphics card and the integrated graphics card.

As an optional implementation, the resource parameter set includes a GPU resource and a video memory resource; and the processor 1300 is configured to:
determine that the hardware resource used for image enhancement processing includes the GPU resource in a case that the network card configuration does not have a condition of performing image enhancement processing in the integrated graphics card, the GPU resource is greater than or equal to a first threshold and the video memory resource is greater than or equal to a second threshold.

As an optional implementation, the resource parameter set further includes a GPU resource; and in a case that the resource parameter set meets the first set condition, the processor 1300 is further configured to:
adjust an enhancement level of an image enhancement algorithm according to the GPU resource, and perform image enhancement processing on the rendered stream by using the adjusted image enhancement algorithm, where the enhancement level is used for representing an intensity of image enhancement.

As an optional implementation, the processor 1300 is further configured to:
notify the server side to adjust the transmission parameters of the application in a case of monitoring that the resource parameter set meets the first set condition; or,
notify the server side to adjust the transmission parameters of the application in a case of monitoring that the resource parameter set meets the first set condition and meets a second set condition, where the second set condition includes: the resource parameters in the resource parameter set reach peak values, where one of the resource parameters corresponds to one of the peak values; or, a network speed in the resource parameter set is less than or equal to a network speed threshold.

As an optional implementation, the transmission parameters include a resolution of the rendered stream.

As an optional implementation, in a case that the resource parameter set meets the first set condition, the processor 1300 is configured to:
perform stream decoding on the rendered stream to obtain a decoded video stream, and perform image enhancement processing on the decoded video stream to obtain an enhanced video stream.

As an optional implementation, the client is deployed on client devices in different network environments, and the network environments are used for representing operating systems or network services of the client devices; and/or,
the server side is deployed in a cloud server and/or a local area network server.

Based on the same inventive concept, an embodiment of the present disclosure provides a computer storage medium. The computer storage medium includes: a computer program code, and the computer program code, when running on a computer, causes the computer to execute any real-time rendering method discussed above. Since the principle of solving problems of the above computer storage medium is similar to that of the real-time rendering method, implementation of the above computer storage medium may refer to implementation of the method, and repetitions are omitted.

In a specific implementation process, the computer storage medium may include: a universal serial bus (USB) flash drive, a mobile hard disk, a read-only memory (ROM), a random access memory (RAM), a magnetic disk or an optical disk and other storage media that can store program codes.

Based on the same inventive concept, an embodiment of the present disclosure further provides a computer program product. The computer program product includes: a computer program code, and the computer program code, when running on a computer, causes the computer to execute any real-time rendering method discussed above. Since the principle of solving problems of the above computer program product is similar to that of the real-time rendering method, implementation of the above computer program product may refer to implementation of the method, and repetitions are omitted.

The computer program product may adopt one or any combination of more readable media. The readable media may be readable signal media or readable storage media. The readable storage media may be, for example, but are not limited to, an electrical, magnetic, optical, electromagnetic, infrared, or semiconductor system, apparatus, or device, or any combination of the above. More specific examples (non-exhaustive list) of the readable storage media include: electrical connection with one or more wires, a portable disk, a hard disk, a random access memory (RAM), a read only memory (ROM), an erasable programmable read only memory (EPROM or flash memory), an optical fiber, a portable compact disk read only memory (CD-ROM), an optical storage device, a magnetic storage device or any suitable combination of the above.

Those skilled in the art will appreciate that embodiments of the present disclosure may be provided as methods, systems, or computer program products. Therefore, the present disclosure may take the form of a full hardware embodiment, a full software embodiment, or an embodiment combining software and hardware. Besides, the present disclosure may adopt the form of a computer program product implemented on one or more computer available storage media (including, but not limited to, a disk memory, an optical memory and the like) containing computer available program codes.

The present disclosure is described with reference to the flow diagrams and/or block diagrams of the method, device (system), and computer program product according to embodiments of the present disclosure. It should be understood that each flow and/or block in the flow diagram and/or block diagram and the combination of flows and/or blocks in the flow diagram and/or block diagram can be implemented by computer program instructions. These computer program instructions can be provided to processors of a general-purpose computer, a special-purpose computer, an embedded processor or other programmable data processing devices to generate a machine, so that instructions executed by processors of a computer or other programmable data processing devices generate a device for implementing the functions specified in one or more flows of the flow diagram and/or one or more blocks of the block diagram.

These computer program instructions can also be stored in a computer-readable memory capable of guiding a computer or other programmable data processing devices to work in a specific manner, so that instructions stored in the computer-readable memory generate a manufacturing product including an instruction device, and the instruction device implements the functions specified in one or more flows of the flow diagram and/or one or more blocks of the block diagram.

These computer program instructions can also be loaded on a computer or other programmable data processing devices, so that a series of operation steps are executed on the computer or other programmable devices to produce computer-implemented processing, and thus, the instructions executed on the computer or other programmable devices provide steps for implementing the functions specified in one or more flows of the flow diagram and/or one or more blocks of the block diagram.

Apparently, those skilled in the art can make various modifications and variations to the present disclosure without departing from the spirit and scope of the present disclosure. In this way, if these modifications and variations of the present disclosure fall within the scope of the claims of the present disclosure and equivalent technologies thereof, the present disclosure is also intended to include these modifications and variations.

1.-32. (canceled)

33. A real-time rendering system, comprising a server side and a client, wherein:
the server side generates an application file and an access address of an application, and configures transmission parameters of the application, the application file comprises a three-dimensional scenario model and logic codes of the application, and the transmission parameters are used for representing parameters required when the application is transmitted from the server side to the client for being displayed;
the server side generates a rendered stream according to the application file, the rendered stream is associated with the access address, and the rendered stream is used for displaying the three-dimensional scenario model of the application in a manner of a video stream; and
the client obtains the access address of the application, establishes communication connection with the server side according to the access address, receives the rendered stream sent by the server side based on the transmission parameters, and performs playing and displaying on the received rendered stream through a client playing medium.

34. The system according to claim 33, wherein the server side comprises a rendering system and a real-time communication server, and the real-time communication server is configured to establish communication connection between the rendering system and the client based on a real-time communication technology; and the server side is configured to:
generate the application file of the application by using the rendering system, configure the transmission parameters of the application and upload the transmission parameters to the real-time communication server; and
generate the access address of the application by using the real-time communication server.

35. The system according to claim 34, wherein after the server side generates the access address of the application by using the real-time communication server, the following is further comprised:
the server side uploads the access address to a service platform, and the server side generates the rendered stream according to the application file and sends the rendered stream to the real-time communication server; and
the client obtains the access address of the application from the service platform, establishes communication connection with the real-time communication server according to the access address, and receives the rendered stream sent by the real-time communication server.

36. The system according to claim 34, wherein the rendering system comprises a three-dimensional rendering engine and a pixel streaming plug-in; and the server side is configured to:
generate the application file of the application by using the three-dimensional rendering engine; and
generate a pixel stream of the application based on the application file by using the three-dimensional rendering engine, and convert the pixel stream into the rendered stream by using the pixel streaming plug-in.

37. The system according to claim 34, wherein the rendering system comprises a configuration interface; and the server side is configured to:
display a configuration option of the application on the configuration interface; and configure the transmission parameters of the application in response to transmission parameters input by a user in the configuration option of the configuration interface; or,
configure the transmission parameters of the application based on self-defined transmission parameters.

38. The system according to claim 34, wherein
the real-time communication server comprises a signaling service, and the signaling service is used for enabling interaction of a plurality of types of signaling between the server side and the client; and/or,
the client comprises a client engine, and the client engine is configured to be connected with the signaling service and perform interaction of a plurality of types of signaling with the signaling service.

39. The system according to claim 38, wherein the real-time communication server comprises the signaling service;
the signaling service is used for establishing communication connection between the rendering system and the client playing medium; or,
the signaling service is used for establishing communication connection between the real-time communication server and the client playing medium; or,
the signaling service is used for establishing a communication service between the client and the client playing medium.

40. The system according to claim 38, wherein the client comprises the client engine, the client playing medium comprises a player, the player is packaged based on Flutter language and supports a plurality of transmission protocols, and the player is applied to clients in different network environments;
in response to an interaction instruction executed by a user on the player, the client sends the interaction instruction to the signaling service through the client engine; and
the signaling service sends the interaction instruction to the rendering system, and the rendering system responds to the interaction instruction and sends a response result to the player through the signaling service.

41. The system according to claim 38, wherein the client playing medium comprises a browser; and the server side is configured to:
in a case that the client, in response to an interaction instruction executed by a user on the browser, sends the interaction instruction to the signaling service,
send the interaction instruction to the rendering system by using the signaling service, respond to, by the rendering system, the interaction instruction and send a response result to the browser through the signaling service.

42. The system according to claim 40, wherein the signaling service comprises a player service and a streamer service;
the client playing medium comprises the player, and the server side is configured to:
send the interaction instruction to the client engine by using the player service, and send the interaction instruction to the signaling service through the client engine; and send the response result to the player by using the streamer service; or,
the client playing medium comprises the browser, and the server side is configured to:
send the interaction instruction to the signaling service by using the player service; and send the response result to the browser by using the streamer service.

43. The system according to claim 33, wherein the application file further comprises interaction logic codes, the rendered stream further comprises a UI interaction interface, and the interaction logic codes are used for generating the UI interaction interface; and
after the playing and displaying is performed on the received rendered stream through the client playing medium, the following is further comprised:
in response to an operation instruction of a user on the UI interaction interface, the client playing medium sends the operation instruction to the server side; and
the server side executes a corresponding operation according to the operation instruction, and sends an operated UI interaction result to the client playing medium.

44. The system according to claim 33, wherein the server side further comprises a material warehouse; and the server side is further configured to:
upload the application file to the material warehouse, and generate a corresponding rendered stream according to the application file stored in the material warehouse.

45. The system according to claim 33, wherein the transmission parameters comprise a startup mode, and the startup mode is used for representing a maximum number of clients accessing a same three-dimensional rendering scenario of the application; and the server side is configured to:
configure the startup mode of the application, such that the same three-dimensional rendering scenario of the application is able to be accessed by a plurality of clients, and the plurality of clients are unable to operate a same element in the three-dimensional rendering scenario simultaneously.

46. The system according to claim 33, wherein the client is further configured to:
obtain a resource parameter set of a client device, wherein the resource parameter set comprises at least one resource parameter, and the resource parameter is used for representing an operation state of the client device;
perform, in a case that the resource parameter set meets a first set condition, image enhancement processing on the rendered stream to obtain an enhanced video stream; and
perform playing and displaying on the enhanced video stream through the client playing medium.

47. The system according to claim 46, wherein the resource parameter set comprises a stream pushing manner of a rendered stream and a network speed; and the first set condition comprises:
a current network speed of the client device is less than or equal to a set network speed threshold; and/or,
a stream pushing manner of a rendered stream received by the client device at this time does not meet a preset requirement;
wherein the stream pushing manner comprises a resolution of a rendered stream; and the first set condition comprises:
a resolution of a rendered stream received by the client device at this time is lower than or equal to a resolution of a rendered stream received last time.

48. The system according to claim 46, wherein the resource parameter set comprises a network card configuration, and in a case that the resource parameter set meets the first set condition, the client is configured to:
determine a hardware resource used for image enhancement processing according to whether the network card configuration comprises a discrete graphics card and an integrated graphics card; and
perform image enhancement processing on the rendered stream by using the hardware resource to obtain an enhanced video stream;
wherein the resource parameter set further comprises a CPU resource; and the client is configured to:
determine that the hardware resource used for image enhancement processing comprises the integrated graphics card and the CPU resource in a case that the network card configuration comprises the discrete graphics card and the integrated graphics card; or
wherein the resource parameter set further comprises a GPU resource and a video memory resource; and the client is configured to:
determine that the hardware resource used for image enhancement processing comprises the GPU resource in a case that the network card configuration does not have a condition of performing image enhancement processing in the integrated graphics card, the GPU resource is greater than or equal to a first threshold and the video memory resource is greater than or equal to a second threshold.

49. The system according to claim 46, wherein the resource parameter set further comprises a GPU resource; and in a case that the resource parameter set meets the first set condition, the client is further configured to:
adjust an enhancement level of an image enhancement algorithm according to the GPU resource, and perform image enhancement processing on the rendered stream by using the adjusted image enhancement algorithm, wherein the enhancement level is used for representing an intensity of image enhancement.

50. The system according to claim 47, wherein the client is further configured to:
notify the server side to adjust the transmission parameters of the application in a case of monitoring that the resource parameter set meets the first set condition; or,
notify the server side to adjust the transmission parameters of the application in a case of monitoring that the resource parameter set meets the first set condition and meets a second set condition, wherein the second set condition comprises: the resource parameters in the resource parameter set reach peak values, wherein one of the resource parameters corresponds to one of the peak values; or, a network speed in the resource parameter set is less than or equal to a network speed threshold;
wherein the transmission parameters comprise a resolution of the rendered stream.

51. The system according to claim 46, wherein in a case that the resource parameter set meets the first set condition, the client is configured to:
perform stream decoding on the rendered stream to obtain a decoded video stream, and perform image enhancement processing on the decoded video stream to obtain an enhanced video stream.

52. The system according to claim 33, wherein the client is deployed on client devices in different network environments, and the network environments are used for representing operating systems or network services of the client devices; and/or,
the server side is deployed in a cloud server and/or a local area network server.
